(19) United States
(12) Patent Application Publication
(10) Pub. No.: US 2026/0278529 A1
(43) Pub. Date: Sep. 17, 2026

(54) SYSTEM

(71) Applicant: SoftBank Group Corp., Tokyo (JP)

(72) Inventor: Goki SUGIMURA, Tokyo (JP)

(73) Assignee: SoftBank Group Corp., Tokyo (JP)

(21) Appl. No.: 19/551,612

(22) Filed: Feb. 27, 2026

Related U.S. Application Data
(60) Provisional application No. 63/770,711, filed on Mar. 12, 2025.

(51) Int. Cl. G06Q 10/083; B60W 60/00; G01C 21/34; G05D 1/229; G06V 20/58; G07C 9/00

(52) U.S. Cl. CPC G06Q 10/0843; B60W 60/00256; G01C 21/3415; G05D 1/229; G06V 20/582; G07C 9/00896; G07C 2009/0092

(57) ABSTRACT

A system includes a processor that is configured to control a movable body having an autonomous driving function; control a locker unit mounted on the movable body, the locker unit being configured to perform receipt and shipment of parcels; optimize a travel route of the movable body based on at least position information of users and parcel delivery demand data; collect, as a data collection unit, the position information of the users and the parcel delivery demand data from one or more external devices including user terminals and delivery service systems; analyze, as an analysis unit, the collected position information and parcel delivery demand data to determine one or more optimal locker placement locations for the movable body; and communicate, as a communication unit, with user terminals so that users can reserve use of the locker unit for receiving and shipping parcels.

### CROSS-REFERENCE TO RELATED APPLICATION

This application claims the benefit of U.S. Provisional Application No. 63/770,711, filed on Mar. 12, 2025, pursuant to 35 U.S.C. § 119(e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional parcel delivery systems relying on fixed lockers or door-to-door deliveries face several technical and operational problems. Fixed parcel lockers cannot dynamically adapt to changes in user traffic patterns and parcel delivery demand, which leads to suboptimal placement, low utilization rates in some areas, and insufficient service in other areas where demand is high or rapidly increasing. Door-to-door deliveries, on the other hand, require significant human labor, are constrained by driver availability, and tend to be inefficient in areas with dispersed populations or in regions where many users, such as elderly or mobility-impaired individuals, have difficulty receiving parcels at home within limited delivery time windows. Furthermore, conventional systems generally do not make full use of real-time user location information and historical delivery demand data to optimize the allocation and movement of delivery resources.

Additionally, existing autonomous or semi-autonomous delivery solutions often focus only on vehicle navigation without tightly integrating locker management, user reservation, and dynamic demand prediction. As a result, even if an autonomous vehicle is available, its route planning may not consider optimal locker placement locations determined from aggregated user position data and parcel demand data. Users are often unable to conveniently check current and future locker positions and to reserve receipt or shipment time slots in a unified manner through their personal terminals. Moreover, conventional systems frequently lack mechanisms for systematically collecting and utilizing user feedback regarding locker locations, time windows, and authentication usability, which hinders continuous improvement of the overall service quality and system performance.
Accordingly, there is a need for a system that can: (i) collect and analyze user position information and parcel delivery demand data; (ii) determine optimal locker placement locations in real time or near real time; (iii) control an autonomous movable body to move and stay at such optimal locker locations during appropriate time periods; (iv) allow users to seamlessly confirm locker positions and reserve receipt and shipment of parcels via smartphone applications; and (v) incorporate user feedback to improve the system over time. The present invention has been made in view of these problems.

### SUMMARY

In order to solve the above-described problems, the present invention provides a system comprising a processor, wherein the processor is configured to control a movable body having an autonomous driving function, control a locker unit mounted on the movable body, and optimize a travel route of the movable body based on at least position information of users and parcel delivery demand data. The processor functions as a data collection unit configured to collect the position information of the users and the parcel delivery demand data from one or more external devices including user terminals and delivery service systems, and further functions as an analysis unit configured to analyze the collected position information and parcel delivery demand data to determine one or more optimal locker placement locations for the movable body. In addition, the processor functions as a communication unit configured to communicate with user terminals so that users can reserve use of the locker unit for receiving and shipping parcels.

According to one aspect of the invention, the processor is configured to control the movable body to move to the one or more optimal locker placement locations determined by the analysis unit and to remain at a corresponding optimal locker placement location during a specified time period. The processor further controls the movable body to recognize a surrounding environment by using one or more sensors comprising at least one of a GPS sensor, a LiDAR sensor, and a camera, and controls the movable body to safely travel to a destination based on the recognized surrounding environment. The processor also selects a travel route for the movable body in consideration of at least traffic signals and interactions with other vehicles, thereby enabling safe and efficient autonomous operation while dynamically responding to predicted parcel demand.
According to another aspect of the invention, the processor is configured to cause a user to confirm, via a smartphone application running on a user terminal, a position of the locker unit and to reserve, via the smartphone application, receipt and shipment of parcels using the locker unit. The processor controls an authentication system of the locker unit to authenticate the user by using at least one of a QR code and an authentication function of the smartphone application so that the user can receive parcels from the locker unit in a secure and contactless manner. Furthermore, the processor is configured to collect feedback from the user via the smartphone application and to store the feedback so as to improve operation of the system based on the collected feedback. By integrating autonomous vehicle control, dynamic locker placement determination, user reservation and authentication functions, and feedback collection into a single coordinated system, the invention enables highly adaptive, user-friendly, and labor-efficient parcel delivery services.

The term “processor” refers to any hardware and/or software based control device, including but not limited to a microprocessor, microcontroller, CPU, GPU, ASIC, FPGA, or a combination thereof, configured to execute instructions and to implement the functions and units described in the claims.

The term “system” refers to a combination of hardware components, software components, communication links, and data structures that collectively implement the functions recited in the claims, including the movable body, the locker unit, user terminals, and the processor. The term “movable body” refers to any vehicle or mobile platform capable of moving in a physical environment, including but not limited to a car, van, truck, robot, or other transport means, which is equipped with an autonomous driving function.
The term “autonomous driving function” refers to a function that enables the movable body to automatically control acceleration, braking, steering, and routing without continuous human intervention, based on sensor inputs, environmental recognition, and route planning algorithms.
The term “locker unit” refers to a physical storage apparatus including one or more compartments or boxes, configured to store parcels securely and to allow users to receive and ship parcels, and mounted on or integrated with the movable body.
The term “parcel” refers to any package, shipment, container, or item intended for delivery or pickup via a logistics or courier service, including but not limited to boxes, envelopes, and goods of various sizes.
The term “travel route” refers to a sequence of positions, waypoints, or paths in a physical space along which the movable body moves between locations, including any associated timing, speed, and stop information.
The term “optimize a travel route” refers to selecting or adjusting a travel route according to one or more criteria such as travel time, distance, safety, predicted parcel demand, traffic conditions, or energy consumption, so as to improve performance relative to at least one of the criteria.
The term “data collection unit” refers to a functional component implemented by the processor, alone or in combination with memory and communication interfaces, that is configured to obtain, receive, and store data, including user position information and parcel delivery demand data.
The term “analysis unit” refers to a functional component implemented by the processor, alone or in combination with memory and software modules, that is configured to process, analyze, and evaluate collected data to derive results such as optimal locker placement locations or demand predictions.
The term “communication unit” refers to a functional component implemented by the processor, alone or in combination with wired or wireless interfaces, that is configured to transmit and receive information between the system and external devices, including user terminals and delivery service systems.
The term “user” refers to any person who interacts with the system, including recipients and senders of parcels, and who utilizes the locker unit and associated applications to reserve, receive, or ship parcels.
The term “user terminal” refers to any electronic device operated by a user, including but not limited to a smartphone, tablet, laptop computer, or wearable device, which is capable of running an application and communicating with the system over a network.
The term “smartphone application” refers to software installed on a user terminal such as a smartphone, configured to provide a user interface for checking locker positions, making reservations, performing authentication, and submitting feedback to the system.
The term “position information of users” refers to location-related data associated with users or their user terminals, including but not limited to GPS coordinates, cell-based location, Wi-Fi-based location, timestamps, and any identifiers or metadata that indicate where and when a user or terminal is located.
The term “parcel delivery demand data” refers to data indicating demand or expected demand for parcel deliveries or shipments in specific areas and time periods, including but not limited to historical delivery records, order volumes, pickup requests, and demand forecasts.
The term “optimal locker placement location” refers to a physical location, area, or stop position selected by the analysis unit as preferable for placing or stopping the movable body with the locker unit, based on one or more criteria such as predicted parcel demand, user density, accessibility, and operational efficiency.
The term “specified time period” refers to a time interval defined by at least a start time and an end time, during which the movable body is controlled to remain at a particular locker placement location for providing services to users.
The term “sensor” refers to any device or module that detects or measures physical quantities or environmental conditions, including but not limited to GPS receivers, LiDAR sensors, cameras, radar sensors, ultrasonic sensors, and inertial measurement units.
The term “GPS sensor” refers to a sensor or module configured to receive signals from a global positioning system and to compute geographic position information such as latitude, longitude, and optionally altitude and time.
The term “LiDAR sensor” refers to a sensor that emits light, typically in the form of laser pulses, and measures reflected light to determine distances to surrounding objects, thereby enabling three-dimensional mapping and object detection.
The term “camera” refers to an optical sensor configured to capture images or video of the surrounding environment, including visible light cameras, infrared cameras, and other imaging devices.
The term “surrounding environment” refers to physical objects and conditions in the vicinity of the movable body, including roads, traffic signs, traffic signals, pedestrians, other vehicles, obstacles, and environmental features such as buildings and intersections.
The term “traffic signals” refers to any signaling devices used to control vehicle and pedestrian traffic, including but not limited to traffic lights, stop signs, yield signs, and other regulatory or warning devices.
The term “interactions with other vehicles” refers to dynamic relationships between the movable body and surrounding vehicles, including but not limited to relative positions, speeds, right-of-way, merging, lane changes, and collision avoidance behaviors.
The term “authentication system” refers to hardware and software components associated with the locker unit and the system, configured to verify the identity or authorization of a user before allowing access to a locker compartment or service.
The term “QR code” refers to a two-dimensional matrix barcode that encodes information such as a token, identifier, or URL, which can be displayed on a user terminal or printed and scanned by an optical reader to support user authentication or reservation verification.
The term “authentication function of the smartphone application” refers to any function within the smartphone application that is used to verify user identity or reservation validity, including but not limited to token-based authentication, NFC-based communication, biometric authentication, or secure credential handling.
The term “feedback” refers to information provided by users regarding their experience with the system, including but not limited to ratings, comments, complaints, suggestions, and usage data related to locker locations, time windows, and usability.
The term “improve operation of the system” refers to modifying one or more aspects of the system's behavior, configuration, or algorithms, such as demand prediction, route planning, locker placement, reservation handling, or user interface behavior, based on collected data or feedback, in order to enhance performance, efficiency, reliability, or user satisfaction.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

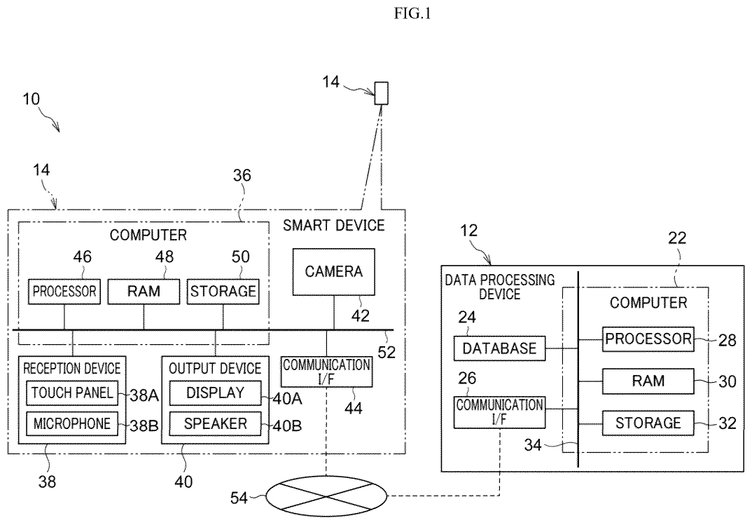

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

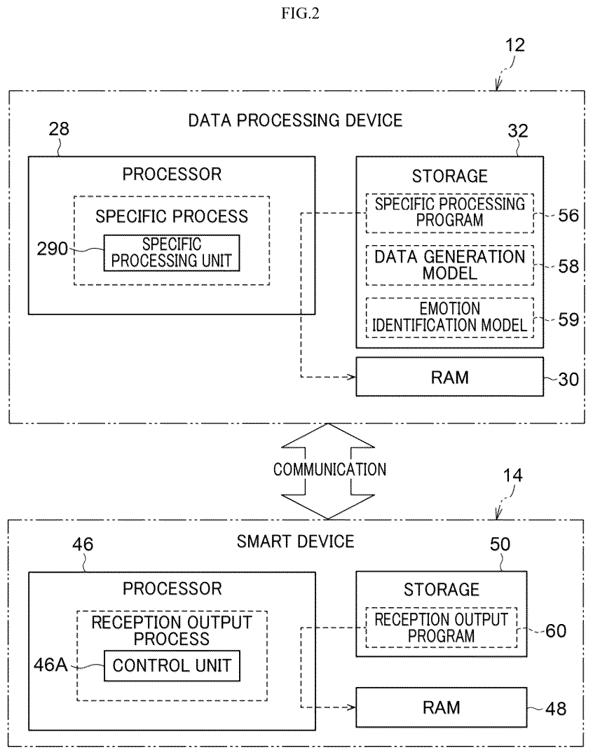

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional systems for managing mobile storage facilities, such as vehicle-mounted lockers, typically rely on static rules, manually designed demand models, or simple heuristics for route planning and locker placement. These systems suffer from several technical limitations in terms of how computing resources process data and control distributed devices.

First, existing systems do not efficiently integrate heterogeneous, large-scale data sources, such as fine-grained user location histories, transportation usage records, delivery histories, and user feedback, into a unified, machine-processable representation. As a result, the processor in such systems cannot generate high-fidelity, time- and region-specific demand predictions, leading to suboptimal computation of placement positions and operation schedules. This manifests as inefficient memory usage for feature storage, repeated redundant computation across data pipelines, and increased latency in generating updated routes and placement plans.
Second, many conventional architectures treat demand prediction, route optimization, and user feedback handling as loosely coupled or offline components. The processor is not configured to iteratively update prediction parameters and routing policies in response to real-time operation results and user feedback. This decoupling causes stale models, degraded prediction accuracy, and non-responsive optimization behavior. From a computing standpoint, there is no unified control loop that feeds back prediction error signals and feedback-derived priority information into the core processing pipeline, and thus the system fails to improve algorithmic performance and resource allocation over time.
Third, traditional systems do not structurally utilize a generative AI model as a first-class component within the computational workflow. When generative models are used at all, they are typically invoked in an ad hoc manner, without a defined prompt sentence structure, without systematic integration of statistical summaries and error metrics, and without clearly defined pathways for propagating model-suggested policies into concrete parameter updates. This results in underutilization of the generative model's ability to assist with algorithm selection, feature engineering strategies, or update policies, and does not improve the internal functioning of the processor in any reproducible way.
Fourth, existing authentication and reservation mechanisms for mobile lockers often rely on static reservations and simplistic access control checks. Processors in such systems do not automatically align reservation slot allocation with optimized, dynamically updated operation plans that consider capacity, staying times, and forecasted demand. The absence of a tightly integrated reservation management and authentication pipeline leads to inconsistencies between the computed schedule and actual user access patterns, potential conflicts in storage capacity, and increased processing overhead for exception handling.
Accordingly, there is a need for an improved computer-implemented system in which a processor is specifically configured to (i) collect and preprocess heterogeneous operational data, (ii) generate and update demand predictions and operation plans in an integrated feedback loop, (iii) systematically interact with a generative AI model through prompt sentences embedding statistical and error information, and (iv) control reservation and authentication flows in alignment with optimized, dynamically updated schedules. Such a system should improve the overall efficiency, adaptability, and robustness of the underlying computing processes involved in locker placement, route planning, and user interaction management.

The specific processing by the specific processing unit 290 of the data processing device 12 in Example 1 is realized by the following means.

The present invention provides a server comprising a processor configured to collect, from user information processing devices and external information sources, heterogeneous data including user position information, transportation usage information, delivery history information, and user feedback information; to perform, on the collected data, computerized preprocessing and feature generation to form structured data sets suitable for machine-based demand prediction; to execute, using the structured data sets, a demand prediction operation that calculates article demand amounts for each time period and each region; to generate, based on the calculated demand amounts and real-time traffic information, an operation plan including at least placement positions and staying times for a movable storage facility; to update, in an iterative feedback control loop, processing parameters of at least the demand prediction operation and the operation plan generation, based on operation results and user feedback; to generate and transmit, to a generative AI model, a prompt sentence including at least statistical information of the collected data and prediction error information of the demand prediction operation, and to receive, from the generative AI model, at least one policy or method relating to demand prediction, feature design, or operation plan updating; to automatically modify internal parameters and evaluation indices of at least one of the demand prediction operation and the operation plan generation based on the received policy or method; to manage reservation slots by allocating, in accordance with the generated operation plan and received reservation requests, time- and capacity-constrained reservation entries; and to generate and verify authentication information associated with the reservation entries so as to control unlocking operations of a storage unit in the movable storage facility. This enables improvement of the internal computing behavior of the server, including more accurate and adaptive demand prediction, more efficient and responsive route and placement optimization, reduced computational redundancy in data processing pipelines, and robust, schedule-consistent reservation and authentication control, thereby enhancing the technical performance of the overall computer-implemented control system.

The term “processor” refers to a hardware-implemented computing device, such as a central processing unit or other programmable computation circuitry, that executes machine-readable instructions to perform data processing, control, and communication operations described herein.

The term “movable body” refers to a physical carrier apparatus capable of traveling within an environment, including but not limited to a vehicle having an autonomous traveling function, that transports and supports a storage facility.
The term “autonomous traveling function” refers to a capability of the movable body to determine and follow a travel route without continuous human operation, by using sensor information and control algorithms to perform at least one of obstacle detection, route following, and speed control.
The term “storage facility” refers to a physical structure mounted to or associated with the movable body and configured to store one or more articles, including at least one storage unit accessible for receipt and dispatch of the articles.
The term “storage unit” refers to a compartment, container, or other subdivided region of the storage facility that is configured to hold at least one article and that can be selectively locked and unlocked under control of the processor.
The term “article” refers to any physical item, package, parcel, or goods intended to be stored in or retrieved from the storage unit.
The term “user information processing apparatus” refers to an electronic device operated by or associated with a user, such as a mobile terminal, communication terminal, or computing terminal, that is capable of executing an application program and communicating with the processor via a communication network.
The term “position information” refers to data representing a geographic or spatial location of at least one of the user information processing apparatus, the movable body, or the storage facility, including but not limited to coordinates, region identifiers, and timestamps.
The term “reservation information” refers to data representing at least one of a requested or assigned time period, location, and capacity for use of a storage unit by a user, including identifiers of a reservation slot and related constraints.
The term “feedback information” refers to data representing evaluations, comments, ratings, or other responses provided by users regarding at least one of storage facility placement, service quality, timing, or accessibility.
The term “transportation usage information” refers to data representing utilization of public or private transportation services, including at least one of boarding times, alighting times, route identifiers, and station or stop identifiers.
The term “delivery history information” refers to data representing past article delivery or collection operations, including at least one of delivery times, delivery locations, storage unit usage, and article handling records.
The term “data collection” refers to an operation in which the processor acquires and records heterogeneous data from one or more sources, including user information processing apparatuses, external information sources, and storage facility controllers.
The term “preprocessing operation” refers to a data processing operation performed by the processor to transform raw data into a normalized or cleaned form, including at least one of filtering, error correction, interpolation, aggregation, and mapping to spatial or temporal units.
The term “feature generation” refers to a data processing operation in which the processor computes derived variables, indicators, or descriptors from preprocessed data, for use as inputs to a demand prediction operation or other computational models.
The term “demand prediction operation” refers to a computational procedure, implemented by the processor, that calculates estimated demand amounts for articles or storage unit usage for each time period and each region, using statistical, machine learning, or other predictive techniques.
The term “demand amount” refers to a quantitative measure of expected or predicted article-related activity, such as a predicted number of deposits, withdrawals, or required storage capacity, within a specified region and time period.
The term “region” refers to a spatial partition or area used for data aggregation and prediction, including but not limited to a grid cell, administrative district, or service zone.
The term “time period” refers to a temporal interval used for data aggregation and prediction, such as a time slot, time window, or time segment of fixed or variable length.
The term “operation plan” refers to structured data generated by the processor that defines at least a placement position and a staying time for the storage facility or storage unit, and that may further include route information, time windows, and capacity allocations.
The term “placement position” refers to a geographic location or point at which the storage facility or storage unit is planned to stop or reside for providing access to users.
The term “staying time” refers to a duration or time window during which the storage facility or storage unit is scheduled to remain at a placement position.
The term “real-time traffic information” refers to data representing a current or near-current state of traffic conditions, including but not limited to congestion levels, travel speeds, incidents, and road closures.
The term “operation result information” refers to data representing actual execution outcomes of the operation plan, including at least one of actual routes traveled, actual staying times, and actual usage of storage units.
The term “mathematical optimization process” refers to a computation performed by the processor that formulates and solves an optimization problem using an objective function and constraints, in order to determine at least one of a position selection and a route selection for the movable body and the storage facility.
The term “position selection” refers to a computational decision to choose one or more placement positions or staying locations for the storage facility from a plurality of candidate positions.
The term “route selection” refers to a computational decision to choose one or more travel paths or sequences of locations for the movable body, subject to constraints such as travel distance, travel time, and capacity.
The term “constraint conditions” refers to quantitative or logical conditions imposed on an optimization process, including but not limited to limits on travel distance, travel time, capacity, number of stops, and service level requirements.
The term “priority information” refers to data representing relative importance or weighting applied to regions, users, or conditions, derived at least in part from feedback information or user attributes, and used to influence demand prediction or optimization.
The term “reservation slot” refers to a logical entry representing an allocation of storage unit access for a user, associated with at least a time period, capacity, and placement position defined by the operation plan.
The term “capacity” refers to a quantitative measure of available storage space or number of articles that can be accommodated in the storage unit or storage facility.
The term “reservation management” refers to a set of operations in which the processor creates, updates, or cancels reservation slots based on operation plans and reservation requests.
The term “authentication information” refers to data used to verify a right of access to a storage unit, including but not limited to identifiers, cryptographic tokens, codes, or credentials.
The term “authentication code” refers to a machine-readable representation of authentication information, including but not limited to a visual code, matrix code, or other encoded symbol suitable for scanning or imaging.
The term “proximity wireless signal” refers to a short-range wireless communication signal used for authentication, including but not limited to a near-field communication signal or other contactless communication signal.
The term “authentication data” refers to data transmitted from a user information processing apparatus or storage facility for verifying a reservation or access right, including at least the authentication information or tokens associated with a reservation slot.
The term “unlocking control information” refers to control data output from the processor to a storage facility controller, instructing a mechanical or electronic locking mechanism to change from a locked state to an unlocked state for at least a portion of a storage unit.
The term “generative AI model” refers to an information processing model, implemented using machine learning or neural network techniques, that generates text or other output data in response to an input prompt sentence.
The term “prompt sentence” refers to a structured sequence of characters, text, or tokens transmitted to the generative AI model, including at least one of statistical information, prediction error information, and summarized feedback information, and requesting at least one of a method, policy, or recommendation.
The term “analysis policy” refers to instructions, guidelines, or strategies produced by the generative AI model and used to configure or adapt how the processor analyzes data or performs prediction and optimization operations.
The term “improvement proposal” refers to content generated by the generative AI model that recommends modifications to algorithms, parameters, features, or workflows used by the processor to perform demand prediction, placement planning, or operation plan updating.
The term “feature design policy” refers to a strategy or guideline, obtained from the generative AI model, for defining, selecting, or transforming input variables used in prediction or optimization operations.
The term “operation plan update policy” refers to a method or rule, obtained from the generative AI model, that specifies how to modify an existing operation plan in response to updated data, feedback, or prediction results.
The term “placement priority setting policy” refers to a method or rule, obtained from the generative AI model, for assigning relative priorities to regions or user groups when determining placement positions or staying times.
The term “user attributes” refers to characteristics associated with users, including but not limited to age group, mobility condition, usage frequency, or geographic distribution, which may influence priority information or placement decisions.
The term “statistical information” refers to aggregated or summarized measures computed from collected data, including at least one of averages, variances, distributions, counts, and correlations.
The term “prediction error information” refers to data quantifying differences between predicted demand amounts and observed demand amounts, including at least one of error values, error distributions, and performance metrics.
The term “evaluation index” refers to a quantitative metric used to assess performance of at least one of a demand prediction operation and an operation plan generation operation, including but not limited to error measures, service level indicators, and computational cost measures.
The term “parameter” refers to a configurable numerical or logical value used in the execution of an algorithm or model by the processor, including at least one of weights, thresholds, learning rates, capacity limits, and priority coefficients.

In one embodiment, a server, a terminal, and a movable body cooperate to implement the claimed system. The server includes at least one processor and a memory, and executes software components deployed on a general-purpose computing platform such as a rack-mounted computer or a virtual machine provided by a cloud computing infrastructure. The terminal includes an information processing device such as a smartphone or tablet, executing an application program. The movable body includes a control unit, a communication interface, and a storage facility having at least one storage unit.

The server executes an operating system, a web application framework, a machine learning framework, and a database management system. For example, the server executes a kernel of a general-purpose operating system, an application server implemented in a server-side framework such as a generic web framework, a numerical computation library such as a tensor-based computation library or a gradient boosting library, and a relational database system. The server also executes a communication module that uses a secure transport protocol such as HTTPS or a message-oriented protocol such as MQTT to exchange messages with the terminal and the movable body.
The server receives, from the terminal, user position information, reservation information, and feedback information. The terminal acquires the user position information by calling location services of a mobile operating system. For example, the terminal calls a location service API to obtain latitude, longitude, timestamp, and accuracy values. The terminal encodes these values into a record having fields of a predetermined schema and transmits a batch of such records to the server. The server stores the received records in a time-series table in the database, partitioned by time and region to enable efficient queries.
The server also receives transportation usage information from an external information source such as a transportation information server, by invoking a RESTful API. The transportation usage information includes, for example, route identifiers, stop identifiers, boarding times, and alighting times. The server stores this information in normalized tables where each record represents an event identified by route, stop, timestamp, and volume. Delivery history information is acquired from a delivery management server via an authenticated API, and stored in tables containing delivery location coordinates, delivery timestamps, and identifiers of storage units used. The server further receives user feedback information from the terminal as structured data including rating values, category identifiers, and free-text comments. The server performs a preprocessing operation on the collected data by executing a data transformation module implemented with a data analysis library. The server removes records with invalid coordinates or timestamps, interpolates short gaps in user traces, and maps raw coordinates to an indexed grid or region identifier. For example, the server converts each coordinate into a cell ID of a two-dimensional grid of fixed spatial resolution. The server aggregates records by region and time period, computing statistics such as counts of unique users, dwell times, and transportation usage. The data are stored in feature tables where rows correspond to a pair of region and time period, and columns correspond to feature values. The server performs a feature generation operation by computing derived indicators. The server generates temporal features such as day-of-week encodings and time-of-day encodings, and spatial features such as distance to nearest transportation stop or distance to a central point of a residential area. The server also generates historical demand features such as rolling averages and lagged demand values. These feature values are stored in a format compatible with a machine learning framework, such as a matrix of numerical arrays and categorical encodings.
The server performs a demand prediction operation by executing a machine learning model. In one embodiment, the server executes a gradient boosting decision tree model. The server uses a training module to read the feature matrices and target demand values from the database. The server divides data into training, validation, and test sets based on time. The server defines a loss function such as mean squared error (MSE) or mean absolute error (MAE), and initializes model parameters such as tree depth, number of trees, and learning rate. During training, the server computes gradients of the loss function with respect to tree splits, constructs trees incrementally, and updates leaf values to minimize the loss. The server evaluates the model on the validation set and stores the trained model in a model storage area. In another embodiment, the server uses a neural network for spatiotemporal prediction. The server constructs a neural network architecture that includes an input layer accepting a concatenation of feature vectors, one or more hidden layers including recurrent units such as long short-term memory (LSTM) units or gated recurrent units, and a fully connected output layer that outputs a demand amount for each time period and region. The server applies an optimization algorithm such as stochastic gradient descent or Adam. The server computes the loss function for a batch of training examples, calculates gradients of network weights via backpropagation, and updates the weights accordingly. The server may perform regularization through dropout or weight decay to prevent overfitting. The server records training metrics and updates model hyperparameters in response to observed prediction errors.
The server generates an operation plan by executing an optimization module. The server formulates a mathematical optimization problem where decision variables include binary variables indicating whether the movable body stops at a candidate placement position during a given time period, and continuous variables representing arrival and departure times. The server defines an objective function that may minimize a weighted sum of travel distance, travel time, and unmet demand. The server defines constraint conditions including capacity constraints on storage units, constraints on maximum daily travel distance, and constraints on service time windows. The server uses an optimization library to solve this problem, generating an operation plan including route information and staying times.
The server then transmits route information, including a sequence of coordinates and planned times, to a control unit of the movable body via the communication module. The movable body executes low-level motion control to follow the route using sensors such as position sensors and environment sensors. The movable body periodically reports its current position and state to the server. The server compares actual positions and times with the operation plan and updates the operation result information.
The server manages reservation information by executing a reservation management module. When the terminal transmits a reservation request indicating desired time and region, the server queries the operation plan and identifies candidate staying times and placement positions. The server checks capacity and conflict conditions and allocates a reservation slot by inserting a record into a reservation table. The server generates authentication information associated with the reservation slot, such as a unique reservation identifier and a cryptographic token generated with a secret key and an expiration time. The server encodes this information into an authentication code, for example a two-dimensional code, and transmits it to the terminal. The terminal displays the authentication code, or stores the token for proximity wireless transmission.
When the user brings the terminal near the storage facility, a reader associated with the storage unit captures the authentication code or receives a proximity wireless signal. The storage facility transmits the authentication data to the server. The server executes an authentication verification module which decodes the data, verifies the cryptographic token, checks whether the corresponding reservation slot exists and is valid at the current time and location, and determines whether the conditions are satisfied. If the conditions are satisfied, the server generates unlocking control information and transmits it to the storage facility, which performs a physical unlocking operation on the corresponding portion of the storage unit.
The server updates the demand prediction operation and the operation plan generation in an iterative feedback loop. The server computes prediction error information by comparing predicted demand amounts with observed demand amounts obtained from actual storage unit usage and delivery records. The server computes error metrics such as mean absolute percentage error and stores these metrics. The server also analyzes user feedback information using a text analysis module based on natural language processing techniques. The server extracts sentiment scores and topic distributions from free-text comments, and computes priority information for regions or user categories. These error metrics and priority values are fed back into the training module and optimization module.
The server utilizes a generative AI model through structured prompt sentences. The server executes a generative AI interface module that assembles a prompt sentence including statistical information of the collected data, prediction error information, and summarized feedback information. For example, the server sends a prompt sentence such as:
“Given the following features: user GPS movement density by region and time, public transit boarding and alighting counts, and historical parcel deliveries, propose an improved machine learning approach to forecast locker demand per region. Suggest specific model types, feature engineering techniques, and ways to handle sparsity in low-demand regions.” In another example, the server sends a prompt sentence such as:
“Explain a method to optimize real-time routes for autonomous delivery vehicles carrying parcel lockers, considering live traffic congestion information, road work reports, and short-term changes in delivery demand. Include how to update routes dynamically while maintaining safety and service level constraints.”
The generative AI model is implemented on an external computation platform and receives the prompt sentence via an API. The server receives a response including an analysis policy or improvement proposal. The server parses the response, identifies recommended model structures, such as using a specific type of recurrent network with region embedding layers, or recommended feature transformations, such as encoding regions with embeddings and including additional lagged features. The server then modifies internal configuration files or parameter sets controlling the training module and optimization module. In this way, the generative AI model is used not to decide outcomes directly, but to configure and improve the computational pipeline. The server thus improves the computing process itself, achieving lower prediction error with less computation due to better feature design and model choice. By structuring the prompt sentences to include concrete statistical and error information, the server enables the generative AI model to output targeted recommendations, and by automatically mapping these recommendations to parameter updates, the system avoids manual trial-and-error adjustments. The use of structured prompt sentences and systematic integration of the generative AI output provides a non-conventional and non-generic way of using AI within the computing system. The server thus performs a technical improvement: the prediction module converges faster during training, uses less memory by discarding low-value features, and reduces inference latency due to more efficient model architectures.
The server reduces communication load between the terminal and the server by batching location information and feedback data, and by employing compact encodings of reservation and authentication data. The server schedules communication intervals adaptively based on observed movement patterns, so that terminals with low movement frequency transmit less often. This reduces network congestion and energy consumption on both the server and the terminal. The server also reduces redundant computation by maintaining intermediate results in cached structures and by incrementally updating aggregated features, instead of recomputing aggregates from raw data every time.
The server's coordinated use of demand prediction, optimization, and feedback-based updating also leads to technical advantages in controlling the movable body. Because the server generates routes and stopping schedules based on fine-grained predictions and updated priorities, the movable body travels fewer unnecessary distances, stops at positions where storage unit usage is likely to be high, and spends less time idle in low-demand regions. This results in reduced power consumption of the movable body, extended lifetime of mechanical components, and improved overall throughput of storage operations.
The terminal executes an application program that communicates with the server and presents information to the user. The terminal displays maps, list views, and reservation forms using the graphics subsystem and a user interface framework. The terminal executes local validation for user inputs, reducing invalid requests. The terminal also generates local caching of reservation and authentication information, so that the terminal continues to function even in environments with temporary connectivity loss. This reduces the need for repeated communication, improving responsiveness and reducing load on the server.
In one variant embodiment, the server replaces the gradient boosting model with a convolutional neural network that receives time-sequenced spatial maps as input. In this case, the server constructs input tensors where each channel represents a feature such as density of user movement or transportation usage, and each spatial location corresponds to a grid cell. The neural network applies convolutional filters to capture local spatial patterns and temporal convolutions to capture time dependencies. The server trains this network using a loss function that includes both prediction error and a regularization term that penalizes rapid spatial changes to encourage smooth demand surfaces. This architecture improves prediction accuracy in complex urban environments, where demand patterns are spatially correlated.
In another variant embodiment, the server uses a reinforcement learning algorithm to adjust route update policies. The server defines a state space including current demand forecasts, traffic information, and movable body positions; defines actions as possible route modifications; and defines a reward function that reflects service level and travel cost. The server trains a policy network that outputs route adjustment decisions. This approach can be augmented by generative AI guidance, where the server uses prompt sentences to obtain reward shaping strategies or state abstraction methods.
In all embodiments, the server performs concrete data transformations, model training steps, and optimization algorithms that are configured to improve computing performance, rather than merely automating a manual routing procedure. The explicit design of data structures, the use of particular model architectures and optimization algorithms, and the integration of generative AI guidance into parameter updates contribute to lower error rates, reduced computation time, and improved scalability. The coupling of these computing processes with physical control of the movable body and physical operation of the storage facility ensures that the system is tied to a specific technological environment, providing technical effects in the real world.

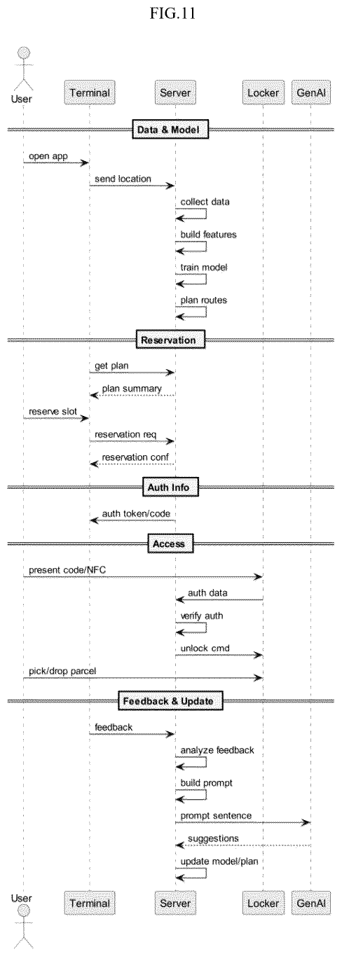

The following describes the processing flow using FIG. 11.

### Step 1:

Server initializes data structures and model configurations.
Server loads, as input, configuration files specifying region definitions, time period granularity, feature schemas, model types, and optimization parameters from persistent storage.
Server parses these configuration files and allocates in-memory data structures such as hash maps for region IDs, arrays for time slots, and schema objects for feature vectors.
Server outputs initialized configuration objects and empty data buffers that will be used in subsequent steps for data collection, feature computation, and model training.

### Step 2:

Terminal acquires user location and context information.
Terminal receives as input sensor readings from a mobile operating system location service, including latitude, longitude, timestamp, and accuracy values, and optionally motion type or speed estimates.
Terminal performs data processing by transforming raw sensor readings into a standardized record structure, for example rounding coordinates to a fixed precision, attaching a user identifier, and discarding samples whose accuracy exceeds a threshold.
Terminal outputs a batch of normalized location records and stores them temporarily in a local buffer for transmission to the server.

### Step 3:

Terminal transmits batched user data to the server.
Terminal receives as input the batched location records and, optionally, locally cached feedback and reservation status updates.
Terminal packages these records into a request message formatted as a structured payload, compresses the payload if its size exceeds a configured limit, and sends the message to the server over a secure communication channel.
Terminal outputs one or more network requests containing the user data, and receives from the server acknowledgments that confirm successful receipt.

### Step 4:

Server collects heterogeneous data from terminals and external sources.
Server receives as input the batched location records from multiple terminals, transportation usage information from transportation APIs, and delivery history information from logistics systems.
Server performs data ingestion operations by validating schemas, discarding malformed entries, assigning region IDs via spatial indexing, and mapping timestamps into discrete time periods. Server writes validated records into time-partitioned and region-partitioned tables in a database.
Server outputs cleaned and indexed raw data tables for location, transportation usage, and delivery history, ready for aggregation and feature generation.

### Step 5:

Server aggregates raw data into spatiotemporal feature candidates.
Server receives as input the indexed raw data tables for a defined time horizon (for example, the last several weeks).
Server executes aggregation queries or batch jobs that count unique users per region and time period, compute average dwell times, calculate boarding and alighting counts per stop and time period, and summarize historical deliveries per region and time period. The server also computes basic statistics such as means, variances, and maximum values for each feature candidate.
Server outputs aggregated feature candidate tables, where each record is keyed by region ID and time period and includes aggregated numerical values for movement density, transportation usage, and past deliveries.

### Step 6:

Server generates model-ready feature vectors and target values.
Server receives as input the aggregated feature candidate tables and configuration rules specifying which features to include and how to encode them.
Server applies feature generation operations such as computing rolling averages, lag features (for example, demand in previous time periods), and categorical encodings for day of week and time of day. Server normalizes numeric features by applying scaling or standardization based on precomputed statistics, and aligns target values by shifting historical demand forward to represent future demand.
Server outputs model-ready datasets composed of feature matrices and corresponding target vectors for each region and time period, separately labeled for training, validation, and testing.

### Step 7:

Server trains a demand prediction model.
Server receives as input the model-ready datasets and hyperparameter settings including learning rate, model depth, number of layers or trees, and regularization terms.
Server executes a training algorithm appropriate to the selected model: for a gradient boosting model, the server iteratively builds decision trees by computing gradients of a loss function such as mean squared error; for a neural network, the server propagates feature vectors forward through network layers, computes loss, performs backpropagation to obtain gradients, and updates weights using an optimization algorithm such as Adam. The server records training and validation errors per epoch or boosting iteration.
Server outputs a trained model artifact, including learned parameters and associated metadata such as feature importance scores and performance metrics.

### Step 8:

Server evaluates and refines the trained model using error analysis.
Server receives as input the trained model and the test dataset that was not used during training.
Server computes predictions for the test dataset, compares these predictions to observed demand values, and calculates error metrics such as mean absolute error, root mean squared error, and error distributions by region and time period. Server identifies systematic under- or over-prediction patterns and generates error summaries grouped by feature values or user categories.
Server outputs detailed evaluation reports and error summary tables, which are used both for internal refinement and as content for prompt sentences to a generative AI model.

### Step 9:

Server generates an operation plan based on predicted demand.
Server receives as input the predicted demand values per region and time period, configuration of available movable bodies, capacities of storage units, and constraints on travel distance and service times.
Server formulates an optimization problem by creating decision variables for stop selection and route sequencing and defining an objective function that balances cost (distance, time) against service quality (satisfied demand, prioritized regions). Server then invokes an optimization solver to compute an optimal or near-optimal set of routes and staying times for each movable body.
Server outputs an operation plan structure, including for each movable body a sequence of waypoints, corresponding time windows, expected demand to be served, and storage capacities assigned per stop.

### Step 10:

Server manages user reservations in coordination with the operation plan.
Server receives as input reservation requests from terminals, each including user identifier, desired time window, preferred region or locker, and parcel characteristics.
Server queries the operation plan and determines feasible stops and time windows that match or approximate user preferences while satisfying capacity constraints. Server selects a specific reservation slot, records an association between the user and that slot in a reservation table, and computes any adjustments necessary to maintain service-level constraints.
Server outputs reservation confirmations that include slot identifiers, precise time windows, placement positions, and generated authentication tokens for each successful reservation.

### Step 11:

Terminal presents reservation options and collects user confirmations.
Terminal receives as input the operation plan summary and available reservation slots communicated by the server.
Terminal renders map-based and list-based views showing locker positions, arrival estimates, and remaining capacity. Terminal then receives user selections for desired slots and prompts the user to confirm the reservation details. Once the user confirms, the terminal sends a reservation request to the server and awaits a confirmation response.
Terminal outputs a reservation confirmation display that includes assigned time, location, and a locally stored authentication code or token provided by the server.

### Step 12:

Server generates and manages authentication information for storage access.
Server receives as input confirmed reservation records including user identifiers, slot identifiers, and expiration times.
Server computes authentication information by combining reservation identifiers with time-based data and signing them using a cryptographic algorithm, producing tokens that cannot be forged without the server's secret key. Server encodes these tokens into authentication codes such as QR codes or prepares them for proximity wireless transfer.
Server outputs encoded authentication information and transmits it to terminals for user presentation, while also storing token validity status in an authentication table for later verification.

### Step 13:

User accesses the storage facility using the terminal.
User receives as input the displayed authentication code or activated proximity wireless credential on the terminal.
User moves to the vicinity of the movable body at a scheduled time and, following the instructions shown on the terminal, positions the terminal in front of a scanner or near a proximity reader on the storage facility. This action causes the scanner to capture the code image or causes the proximity reader to receive the token.
User outputs to the system a physical presentation of the authentication information that triggers a subsequent verification and unlocking process.

### Step 14:

Server verifies authentication data and controls unlocking.
Server receives as input authentication data transmitted from a storage facility controller, including captured code or proximity token values and an identifier of the storage unit being accessed.
Server decodes the authentication data, validates the cryptographic signature and expiration time, and cross-references the token with reservation and operation plan records to ensure that the access attempt occurs within an authorized time window and at an authorized storage unit. If all conditions are satisfied, the server constructs unlocking control commands that specify which compartment to unlock and for how long.
Server outputs unlocking control information to the storage facility controller, which then actuates a lock mechanism, and also outputs an updated status for the reservation indicating that it has been used or completed.

### Step 15:

Server records operation results and updates usage statistics.
Server receives as input status reports from storage facility controllers and movable body controllers, including actual arrival times, departure times, door open and close events, and any error codes.
Server processes these reports by associating them with corresponding operation plan entries and reservations, computing deviations between planned and actual times, and updating usage counters such as number of parcels handled per stop and average dwell time.
Server outputs operation result records and updated statistics tables that serve as inputs for subsequent prediction, optimization, and feedback analysis cycles.

### Step 16:

Server processes user feedback and derives priority information.
Server receives as input feedback submissions from terminals, including numerical ratings and free-text comments, and associates them with specific stops, time slots, and user attributes.
Server performs text processing by tokenizing comments, removing common words, and applying sentiment and topic analysis using a natural language processing module. Server then aggregates sentiment scores and topics per region and per user category, converting them into quantitative priority values that indicate which regions or groups should receive more or less service emphasis.
Server outputs updated priority information and feedback summaries, which are stored in data structures that influence both demand prediction features and optimization objective weights.

### Step 17:

Server constructs prompt sentences for the generative AI model.
Server receives as input statistical aggregates of the collected data, prediction error metrics, and feedback-derived priority information.
Server formats these inputs into textual descriptions and embeds them into a structured prompt template. For example, the server constructs a prompt sentence such as: “Given the following features: user GPS movement density by region and time, public transit boarding and alighting counts, and historical parcel deliveries, propose an improved machine learning approach to forecast locker demand per region. Suggest specific model types, feature engineering techniques, and ways to handle sparsity in low-demand regions.”
Server outputs one or more complete prompt sentences that capture the current system state and known issues, ready to be sent to a generative AI model via an external API.

### Step 18:

Server transmits prompt sentences to the generative AI model and receives recommendations. Server receives as input the constructed prompt sentences and configuration parameters for the generative AI interaction, such as model endpoint, temperature, and maximum output length.
Server sends the prompt sentences to a generative AI model over a secure network connection, waits for responses, and then parses the received texts to extract concrete recommendations, such as suggested model architectures, feature transformations, or route update policies.
Server outputs structured representations of the recommendations, mapping them into internal configuration changes or candidate experiment settings for the demand prediction and optimization modules.

### Step 19:

Server updates internal models and optimization parameters based on generative AI guidance. Server receives as input the structured recommendations derived from the generative AI responses and the current configuration of models and optimization routines.
Server compares recommended strategies with existing settings, selects non-conflicting improvements such as adding specific lag features, modifying regularization strengths, or adjusting weights in the optimization objective, and writes these changes into configuration storage. When appropriate, the server triggers re-training of models or re-computation of operation plans using the updated configurations.
Server outputs updated model parameters, revised configuration files, and, if recomputation is performed, new trained model artifacts and updated operation plans.

### Step 20:

Terminal updates displayed information and interaction behavior according to revised plans. Terminal receives as input updated operation plans, reservation availability data, and any changes to user-facing parameters such as time windows or prioritization hints communicated by the server.
Terminal refreshes its internal caches and user interface components, updating maps, lists of locker stops, and reservation options. The terminal may also adjust notification schedules based on new arrival times and priority levels, thereby improving the timeliness and relevance of alerts presented to the user.
Terminal outputs an updated interactive display that reflects the latest system state, allowing the user to make informed reservation choices and interact smoothly with the optimized, AI-assisted locker network.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional logistics automation systems that employ autonomous mobile bodies, sensor networks, and rule-based optimization typically suffer from several technical limitations at the computing-system level. First, route planning and task scheduling are often performed by static algorithms and fixed parameter sets that are tuned manually and infrequently. As a result, the underlying processor cannot adequately adapt to rapid fluctuations in article inflow, localized congestion, and heterogeneous work conditions, which leads to increased computation overhead for re-planning, sub-optimal utilization of processing resources, and unstable latency characteristics in control loops.

Second, in many existing systems, prediction of article inflow and work load, generation of sorting plans, and optimization of travel routes are implemented as separate software modules without a unified feedback mechanism. The processor thus executes each module based on outdated models or manually defined rules, and there is no structured way to incorporate performance logs and user feedback into algorithm updates. This separation causes redundant data processing, increased memory transfers, and fragmented state management across multiple processes, degrading cache efficiency and overall throughput of the computing platform.
Third, known approaches that attempt to improve performance typically rely on human experts to analyze logs and tune model parameters offline. This manual tuning process is slow, error-prone, and does not scale with the volume and complexity of operational data. From the perspective of computer technology, the processor is under-utilizing the available data and is not architected to support continuous, in-situ learning and configuration refinement during normal operation, thereby limiting the adaptability and robustness of the control algorithms executed by the processor.
Fourth, even when advanced learning techniques are introduced, they are often confined to individual machine learning models, such as demand forecasting, and do not provide a mechanism for automatically proposing higher-level changes to algorithm structures, feature sets, or control policies. In particular, there is no integrated mechanism by which a processor can transform its own operation history, congestion metrics, error patterns, and user feedback into structured input for a higher-capacity generative model, and then systematically project the response of that model back into concrete updates of prediction, planning, and routing logic. Consequently, the processor cannot efficiently exploit generative models as part of its internal optimization loop, and potential improvements in scheduling and control behavior remain unrealized.
Therefore, there is a need for a system architecture and processing method in which a processor: (i) unifies acquisition of identification and environment information, prediction of article inflow and work load, generation of sorting plans, optimization and control of autonomous mobile bodies, and collection and analysis of feedback; and (ii) automatically cooperates with a generative information processing model through structured prompt sentences derived from its own logs and performance indicators, so that algorithms and parameters for prediction, sorting plan generation, and route optimization can be continuously and systematically adjusted. By addressing these issues at the level of processor configuration and data flow, the invention aims to improve computational efficiency, responsiveness, stability, and adaptability of the underlying computer system that manages automated logistics operations.

The specific processing by the specific processing unit 290 of the data processing device 12 in Application Example 1 is realized by the following means.

The present invention provides a server comprising a processor configured to execute instructions to: read identification information assigned to a plurality of articles by use of an information reading unit; acquire position information of the articles and work environment information by use of an environment information acquisition unit; store the acquired information in time series form and predict an inflow amount of the articles and a work load by use of a prediction unit; determine, on the basis of a prediction result by the prediction unit and attribute information of the articles, a sorting destination and a sorting order of the articles by use of a sorting plan generation unit; dynamically optimize, on the basis of a congestion degree and safety calculated from the work environment information, a travel route of a movable body having an autonomous driving function that transports the articles to movement destinations determined by the sorting plan generation unit by use of a route optimization unit; control, by use of a movable body control unit, an operation of the movable body and a transport process of the articles in accordance with the travel route and a work instruction determined by the route optimization unit; provide, by use of a communication unit, state information of the articles, work instruction information, and abnormality notification information to an information processing terminal operated by a user, and receive input information from the information processing terminal; collect evaluation information and operation history information from the user, analyze the collected information in association with work efficiency indices, and update operation conditions of the route optimization unit and the sorting plan generation unit by use of a feedback analysis unit; and generate a prompt sentence including an explanation based on an operation history of the system, the prediction result, the congestion degree information, and the evaluation information from the user, input the prompt sentence to a generative information processing model, and automatically or semi-automatically adjust an algorithm or a parameter of the prediction unit, the sorting plan generation unit, and the route optimization unit on the basis of a response obtained from the generative information processing model by use of a generative information processing cooperation unit. This enables the server to implement an integrated, feedback-driven control loop in which acquisition, prediction, planning, optimization, and control are continuously adapted in real time, reduces redundant data processing and manual parameter tuning, improves the efficiency and stability of route and schedule computation under varying workloads and congestion conditions, and leverages a generative model in a structured manner to enhance the performance and adaptability of the underlying computer system.

The term “article” refers to any physical item, package, parcel, or good that is handled, transported, or stored by the system, and that is associated with identification information and attribute information.

The term “identification information” refers to data that uniquely or semi-uniquely identifies an article, such as a code, number, or symbol, including but not limited to radio-frequency identification data, bar codes, or optical codes.
The term “information reading unit” refers to any hardware and software combination configured to read identification information from an article, including but not limited to radio-frequency identification readers, optical code readers, and associated driver or interface software.
The term “environment information acquisition unit” refers to any hardware and software combination configured to acquire information relating to a physical environment in which articles are handled, including but not limited to sensors, imaging devices, and data acquisition software.
The term “position information” refers to data indicating a location of an article or a movable body within a defined coordinate system, such as a map of a storage area or transport area, and may include coordinates, zone identifiers, or track positions.
The term “work environment information” refers to data describing a state of an area in which articles are handled, including but not limited to presence and movement of objects, occupancy of routes, sensor readings, and detection of obstacles or congestion.
The term “prediction unit” refers to any software module or combination of software modules executed by a processor and configured to generate prediction results, including predictions of article inflow, work load, or other time-dependent quantities, by processing time series data or other input data.
The term “inflow amount” refers to a predicted or measured quantity of articles that enter a defined area or system during a given time period.
The term “work load” refers to a predicted or measured amount of processing, handling, or transport operations required within a given time period, and may be expressed in terms of number of tasks, processing time, or resource usage.
The term “sorting destination” refers to a target location or category to which an article is assigned for grouping, staging, or dispatch, such as a bin, rack, zone, or shipping group.
The term “sorting order” refers to a sequence or priority in which articles are to be processed, moved, or stored, as determined by a sorting plan.
The term “sorting plan generation unit” refers to any software module or combination of software modules executed by a processor and configured to determine sorting destinations and sorting orders for articles on the basis of prediction results, attribute information, and other operational constraints.
The term “attribute information” refers to data describing characteristics of an article, including but not limited to weight, size, destination region, delivery deadline, service level, and handling requirements.
The term “movable body” refers to any mobile platform capable of transporting articles within a storage area or transport area, including but not limited to autonomous vehicles, robots, or automated guided vehicles.
The term “autonomous driving function” refers to a capability of a movable body to determine and execute its own motion within an environment, at least in part, by processing sensor information and control instructions without continuous direct human control.
The term “travel route” refers to a path or sequence of positions that a movable body is to follow within a storage area or transport area to accomplish a designated task.
The term “congestion degree” refers to a quantitative or qualitative index representing a level of occupancy, traffic density, or interference in a region of a storage area or transport area.
The term “route optimization unit” refers to any software module or combination of software modules executed by a processor and configured to compute or update travel routes for movable bodies on the basis of cost values, congestion information, safety constraints, and task requirements.
The term “movable body control unit” refers to any software module or combination of software modules executed by a processor and configured to generate control commands for a movable body so as to implement travel routes and work instructions, including commands for movement, pickup, and placement of articles.
The term “work instruction” refers to a directive or specification of an operation to be performed by a movable body or by a user, such as picking an article, placing an article, or moving to a specified location.
The term “communication unit” refers to any hardware and software combination configured to transmit information from a server to an information processing terminal and to receive information from the information processing terminal, using one or more communication protocols.
The term “information processing terminal” refers to any computing device operated by a user and configured to send or receive information to or from the system, including but not limited to handheld terminals, portable terminals, fixed terminals, and display devices.
The term “evaluation information” refers to data representing assessments, ratings, or qualitative feedback provided by a user regarding system behavior, performance, usability, or other operational aspects.
The term “operation history information” refers to data indicating past operations executed by the system or by users, including logs of tasks, events, states, and control actions, stored over time.
The term “work efficiency index” refers to a numerical or categorical indicator that quantifies efficiency of operations, including but not limited to throughput, average processing time, utilization rate, or delay rate.
The term “feedback analysis unit” refers to any software module or combination of software modules executed by a processor and configured to analyze evaluation information and operation history information, associate them with work efficiency indices, and derive updates or adjustments to operational conditions of other units.
The term “operational condition” refers to a setting, rule, or parameter that influences behavior of a software module, including threshold values, weight coefficients, priority rules, or scheduling policies.
The term “prompt sentence” refers to text or structured input generated by the system and supplied to a generative information processing model, the text including explanations, summaries, or contextual information derived from system data.
The term “generative information processing model” refers to an information processing model, such as a generative artificial intelligence model or language model, configured to output a response in natural language or other structured form based on a prompt sentence or other input.
The term “generative information processing cooperation unit” refers to any software module or combination of software modules executed by a processor and configured to generate prompt sentences from system data, supply the prompt sentences to a generative information processing model, receive responses from the generative information processing model, and translate at least part of the responses into updates of algorithms or parameters used by other units.
The term “algorithm” refers to a computational procedure or method executed by a processor to transform input data into output data, including but not limited to prediction methods, optimization procedures, routing strategies, or decision rules.
The term “parameter” refers to a value used by an algorithm to control its behavior or weighting, such as a coefficient, threshold, limit, or tuning constant.
The term “region-specific congestion degree index” refers to a congestion degree calculated for a particular region or zone within a storage area or transport area on the basis of environment information, including sensor data and image analysis results.
The term “route network” refers to an abstract representation of a storage area or transport area as a set of nodes and edges, where edges correspond to possible travel paths for a movable body and nodes correspond to positions or intersections.
The term “cost value” refers to a numerical value associated with an edge or segment in a route network, used by a route optimization unit to evaluate and select travel routes, and may represent time, distance, risk, congestion, or a combination thereof.
The term “weighting rule” refers to a rule or function that determines how individual factors, such as distance, congestion, or safety margins, are combined or scaled to compute a cost value or other aggregated metric.
The term “congestion determination threshold” refers to a value or set of values used to classify a congestion degree as belonging to one of multiple categories, such as normal, congested, or highly congested.
The term “sorting error occurrence situation” refers to a state or pattern characterized by misplacement, misclassification, or incorrect routing of articles relative to intended sorting destinations or orders.
The term “delay occurrence situation” refers to a state or pattern characterized by completion times of operations or deliveries exceeding target times or deadlines.
The term “comment information” refers to free-form text or structured annotations provided by a user, expressing observations, complaints, suggestions, or other narrative feedback about system behavior or performance.
The term “priority determination rule” refers to a rule or set of rules that defines how priorities are assigned to articles, tasks, or operations, based on attributes, deadlines, or other criteria.
The term “instruction content” refers to text, symbols, or visual representations that specify actions or guidelines presented to a user or operator through an information processing terminal.
The term “user interface presentation format” refers to a layout, style, or interaction pattern in which information is displayed or input on an information processing terminal, including arrangement of elements, use of colors or icons, and navigation structure.
The term “priority assignment process” refers to a processing sequence executed by the sorting plan generation unit to assign priority levels or processing orders to articles or tasks based on priority determination rules.
The term “information presentation process” refers to a processing sequence executed by the communication unit to format, select, and transmit information to be displayed on an information processing terminal.

In one embodiment, a server cooperates with one or more terminals and users to implement the claimed system in a logistics facility such as a warehouse or distribution center. The server includes at least one processor, a main memory, a non-volatile storage device, and a network interface. The server executes software modules corresponding to an information reading unit, an environment information acquisition unit, a prediction unit, a sorting plan generation unit, a route optimization unit, a movable body control unit, a communication unit, a feedback analysis unit, and a generative information processing cooperation unit. The terminals include portable or fixed information processing terminals operated by users, and embedded computers mounted on movable bodies having an autonomous driving function.

The server executes an operating system, such as a general-purpose server operating system, and application software implemented, for example, in a high-level language. The server stores executable modules and configuration data in the non-volatile storage device and loads them into the main memory when operating.
The server implements the information reading unit by executing a device interface module that communicates with radio-frequency identification readers, optical code readers, or combined multi-mode scanners installed at gates, shelves, or workstations. The server receives raw read events via network protocols such as Transmission Control Protocol/Internet Protocol and parses them into records containing a tag identifier, a reader identifier, a timestamp, and a signal quality indicator. The server stores each record in a structured data table in the main memory or in a relational database, using a schema that maps the tag identifier to an internal article identifier, an article type, and attribute information such as weight, size, destination region, and delivery deadline. By using a compact, index-based data structure for storing article identifiers and attribute vectors, the server reduces memory bandwidth requirements and accelerates later join operations with prediction and planning modules.
The server implements the environment information acquisition unit by executing sensor drivers and data collection services that interface with imaging devices and other sensors deployed in the logistics facility. The server receives video streams from imaging devices via streaming protocols and decodes frames into image matrices in the main memory. The server also receives measurements from distance sensors, pressure sensors, or other detectors via message-based protocols and stores them in time-stamped series. The server associates each measurement or detection result with a spatial coordinate or a region identifier by applying calibration parameters and coordinate transformation matrices stored in the storage device. The server aggregates the measurements into environment information structures that contain, for each region in a route network, a vector of features such as current occupancy count, average velocity of movable bodies, and presence of static obstacles.
The server implements the prediction unit by executing a machine learning module that forecasts article inflow and work load. In one embodiment, the server stores, in a training data table, records containing features including, for example, a time-of-day index, a day-of-week index, a holiday flag, previous inflow counts, destination distribution, and recent congestion metrics. The server trains a model such as a gradient-boosted decision tree model, a random forest, or a feedforward neural network having an input layer, one or more hidden layers, and an output layer that outputs predicted inflow amounts for future time intervals and predicted work load values for different zones. When the server uses a neural network, the server initializes weight parameters, defines an error function such as a mean squared error between predicted inflow values and measured inflow values, and performs batch or mini-batch gradient descent to update the weights. The server obtains gradients by backpropagation and updates the weights according to an update rule such as stochastic gradient descent with momentum or an adaptive gradient method. The server stores the trained model parameters in a model registry, and during operation, the server loads the parameters into the main memory and executes numerical operations on vector and matrix data using a numerical library. By representing prediction inputs as fixed-length feature vectors and performing batched inference, the server improves cache locality and reduces the number of function calls required to generate forecasts, thereby improving throughput of prediction processing. The server implements the sorting plan generation unit by executing an optimization module that constructs a sorting plan from prediction results and attribute information. The server prepares, in the main memory, a list of articles, each associated with a feature vector that includes at least an internal article identifier, a predicted arrival time, a destination region code, an article size class, an article weight class, a delivery deadline, and a service level indicator. The server defines a set of sorting resources, such as bins or zones, represented by identifiers and capacity constraints. The server formulates a mathematical optimization problem, for example a mixed-integer programming problem, in which binary decision variables represent assignment of articles to sorting destinations and ordering variables represent precedence relations. The server defines an objective function that penalizes late completion, excessive walking distance, and imbalance of loads across resources. The server then calls a solver library to solve the optimization problem and obtain an assignment and an ordering. The server writes the solution into a sorting plan table that includes for each article a sorting destination identifier, a target handling time interval, and a priority score. Because the server formulates and solves the optimization problem programmatically, based on up-to-date prediction outputs and environment information, the server can recompute feasible sorting plans more frequently than a human operator and can adjust to changing workloads without human tuning, thereby improving computational responsiveness.
The server implements the route optimization unit by representing the logistics facility as a graph structure in the main memory, in which nodes correspond to intersections, shelves, or docking positions, and edges correspond to traversable segments. The server assigns to each edge a base cost such as geometric distance and augments the base cost with additional components determined by congestion degrees, safety margins, and priorities. The server stores, for each region, a region-specific congestion degree index derived from sensor measurements and environment information. The server updates edge costs in real time by applying weighting rules that combine base distances and congestion indices according to a cost function. For example, the server may compute an edge cost as a weighted sum of travel time and predicted delay, using weights that depend on a time-of-day slot. The server then runs a pathfinding algorithm such as a shortest-path algorithm or an A* search on the graph, using the dynamic costs, to compute travel routes for movable bodies. The server iterates the pathfinding procedure when significant changes in congestion are detected and updates the assigned routes stored in a route table. Since the server uses the region-specific indices as input to the edge cost computation and performs dynamic adjustment of the costs, the server reduces unnecessary recomputation of entire route plans and focuses processing on regions where congestion changes, which enhances computational efficiency and stability of route generation.
The server implements the movable body control unit by generating and transmitting control commands to controllers mounted on movable bodies. Each movable body includes an embedded terminal that executes a local control program, as well as sensors such as localization sensors and object detection sensors. The server maintains, in a state table, for each movable body, its current node identifier in the route network, its orientation, its battery level, and its current task state. When the route optimization unit updates a travel route, the server converts the node sequence into motion primitives such as waypoints, velocities, and timing constraints. The server transmits these motion primitives to the terminal via the network interface. The terminal receives the primitives and performs low-level closed-loop control using sensor measurements; the server does not continuously control the actuators directly but periodically updates the high-level route and task commands. By separating high-level planning on the server from low-level control on the terminal, the system reduces the computational burden on the server while maintaining the ability to globally coordinate many movable bodies.
The terminal mounted on each movable body runs a control algorithm that includes local perception, localization, and trajectory following. The terminal reads sensor data such as point clouds and images, and executes object detection algorithms, for example a convolutional neural network trained for obstacle detection. The terminal determines an instantaneous control command for the drive system based on a comparison between the current pose and the desired waypoint sequence received from the server. The terminal estimates its pose by fusing sensor data using a localization algorithm such as an extended Kalman filter or a particle filter. The terminal periodically sends back to the server a summarized status message containing the current pose, speed, and task state. This closed loop between server and terminal ensures that high-level scheduling and routing decisions remain synchronized with the actual physical movements.
The server implements the communication unit by providing an application programming interface for terminals operated by users. The server exposes, via a network interface, endpoints for retrieving article state information, work instruction information, and abnormality notifications, and for receiving updates, confirmations, and feedback from users. The server transmits notification messages to terminals using push mechanisms when certain triggers occur, such as detection of a route blockage or identification of a sorting error. The server aggregates messages into batches when possible to reduce the number of network transactions, thereby lowering communication overhead. The terminal, which may be a handheld device or a stationary display, displays information received from the server in a user interface, and accepts user input such as confirmation of completion, error reports, or comments.
The server implements the feedback analysis unit by executing statistical and machine learning algorithms on evaluation information and operation history information. The server stores evaluation information in a feedback table that includes a user identifier, a timestamp, a category field and a numeric rating or text comment. The server associates these feedback records with corresponding operation history records including, for example, routes followed, delays encountered, and errors logged. The server computes work efficiency indices such as throughput, average handling time, and route deviation metrics for each region and time interval. The server applies correlation analysis and clustering to identify patterns, such as regions with frequently low ratings or routes with frequent delays. The server then adjusts operational conditions, such as congestion thresholds and weight coefficients in cost functions used by the route optimization unit, or priority rules used by the sorting plan generation unit. Because the server stores the feedback and operation history in a structured form and processes them algorithmically, the server can systematically and repeatedly refine parameters based on quantitative metrics, which reduces dependence on manual tuning.
The server implements the generative information processing cooperation unit by converting internal system data into prompt sentences and applying these prompt sentences to a generative AI model deployed either on an internal computing resource or via a remote service. The server selects from its logs relevant data such as operation history summaries, prediction errors, distribution of congestion indices, and aggregated feedback comments, and formats this data into human-readable explanatory text. For example, the server may construct a prompt sentence as follows:
“Current warehouse data show repeated congestion in zone B between 16:00 and 18:00, with average traversal time 25% higher than in other zones. Forecast errors for parcel inflow in this time window are larger than in other periods. Workers often report that vehicles slow down excessively in zone B. The current route cost function uses a uniform congestion penalty and static speed limits. Propose modifications to the routing algorithm, including how to adjust congestion penalties per zone and time, and how to modify the feature set of the inflow prediction model to reduce forecast error.”
In another example, the server may generate a prompt sentence:
“Based on the following data: (1) sorting errors occur primarily for medium-sized articles destined to region R3; (2) delays above target thresholds concentrate on routes passing through zone C; (3) worker comments indicate that instructions on the handheld terminal are unclear in these cases. Suggest changes to article priority rules, route selection logic, and user interface presentation that can reduce errors and delays.”
The server sends such prompt sentences as plain text to the generative AI model via a defined programmatic interface. The generative AI model may be, for instance, a transformer-based neural network with multiple attention layers, trained on large volumes of text data. The server receives the natural language response and parses it to extract specific proposals, such as recommended changes to parameters, feature selection, or thresholds. The server then maps these proposals into concrete modifications of configuration files or database entries. For example, the server may update a configuration entry that specifies different congestion penalty weights for specific zones and times, or may add a new binary feature “near-holiday flag” to the feature list used by the prediction unit. The server may also write a change request record for more complex algorithmic modifications that require human review. This cooperative loop allows the server to incorporate complex, higher-level reasoning into its own configuration process while still controlling the exact numerical changes and ensuring consistency with existing data structures.
Because the server transforms structured logs into prompt sentences and then converts responses back into configuration values, the cooperation between the server and the generative AI model is not a simple delegation of decision-making but a structured optimization of the internal computational behavior. The server defines, for example, which features and parameters are adjustable and how the responses can be translated into valid configurations. As a result, the server improves the performance of its internal algorithms, such as reducing prediction error, shortening route computation times by focusing search on feasible regions, and decreasing the number of re-plans needed when congestion patterns change. These improvements represent enhancements to the functioning of the computer system itself, such as improved cache usage due to more stable route patterns, reduced lock contention in shared data structures, and fewer network messages triggered by erroneous or unstable plans.
In one variation, the server implements the generative information processing cooperation unit so that the server supplies not only textual summaries but also encoded representations of time series data and model metrics, and instructs the generative AI model to output machine-readable configuration parameters in a simple markup format. The server parses the markup and directly updates configuration tables. In another variation, the server restricts the generative AI model to produce recommendations only, and requires a human engineer to review and approve the proposed changes before application. The server may store multiple candidate configurations and perform controlled experiments, for instance by assigning different routing schemes to different zones and comparing their work efficiency indices. The terminal operated by the user provides a graphical or textual user interface that reflects the current state and instructions generated by the server. The terminal displays, for example, a list of tasks, including inspection requests, anomaly handling instructions, and feedback prompts. When the server detects a repeated pattern of errors associated with a particular type of article or region, the server may update the instruction content and user interface presentation format based on proposals obtained from the generative AI model. The server then transmits the updated interface configuration to the terminal. As a result, the terminal presents improved, context-sensitive guidance to the user, such as clearer descriptions of tasks or reorganized layout of critical information, which reduces human input errors and shortens decision times.
The user interacts with the terminal to confirm tasks, report anomalies, and provide feedback. The user's actions generate operation history and evaluation information that the server records and analyzes. Through this interaction, the server collects data necessary to evaluate the effectiveness of algorithm updates derived from the generative AI cooperation. For example, if the server applies a new routing weight scheme recommended by the generative AI model, and thereafter the server observes reduced delays and improved ratings for affected zones, the server confirms the technical effectiveness of the change and may preserve the new configuration. Conversely, if performance degrades, the server can revert to a previous configuration stored in versioned configuration tables.
Because the server integrates environment sensing, prediction, optimization, and generative AI cooperation into a unified architecture, the system provides technical effects beyond simple automation of human planning. The server reduces computation time for route planning and sorting plan generation by using dynamically weighted cost functions and by reusing models whose parameters are actively maintained at an optimal range. The server reduces error rates in sorting and routing by continuously adjusting priority rules and thresholds based on quantitative feedback. The server reduces data movement overhead by maintaining shared, normalized data structures for article states, environment information, and configuration parameters, and by batching operations when possible. The server reduces communication overhead by sending only aggregated status updates and compressed instructions instead of continuously streaming all internal calculation details to terminals. Alternative embodiments can vary the specific machine learning models, algorithms, and data structures while maintaining the core architecture in which the server executes prediction, sorting plan generation, route optimization, feedback analysis, and generative AI cooperation. For example, the server may implement the prediction unit using a recurrent neural network or a temporal convolutional network that captures temporal dependencies in inflow patterns. The server may implement the route optimization unit using a reinforcement learning based policy that outputs edge preferences; in such a case, the server may define a reward function that penalizes delays and collisions and uses environment history to update policy parameters. The generative information processing cooperation unit may be used to suggest modifications to the reward function structure or to the input feature set of the policy network. The server may also apply different generative AI models for different purposes, such as one model specialized in algorithm design suggestions and another in user interface wording. In all such embodiments, the server structures the flow of data through well-defined tables and feature vectors, processes data using explicit algorithms and models, and employs a generative AI model as an auxiliary component whose outputs are systematically integrated into algorithm and parameter updates. This architecture ties high-level analysis and model-based adaptation directly to control of physical movable bodies and to the management of sensor-driven environment representations, thereby providing concrete improvements to computer technology in terms of processing efficiency, control stability, and error reduction.

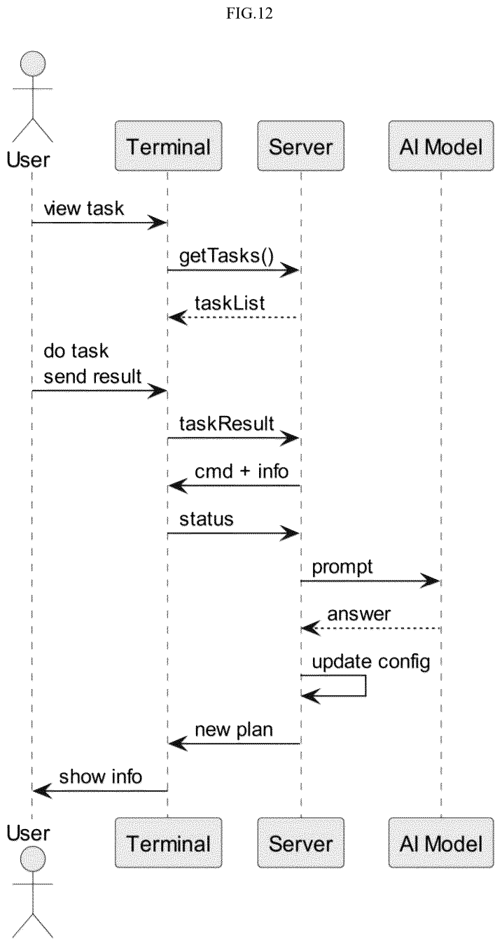

The following describes the processing flow using FIG. 12.

### Step 1:

Server acquires identification information and initializes article records.
Server receives, as input, raw read events from information reading units, including identification codes (such as RFID tags or barcodes), reader identifiers, and timestamps. Server parses each event into structured fields and looks up or generates an internal article ID. Server then performs data processing by mapping each identification code to an internal article record, attaching attribute information (such as weight class, size class, destination region, and delivery deadline) retrieved from a database. As output, server stores normalized article records in an article table and generates arrival events that become input to subsequent processing.

### Step 2:

Server acquires environment information and computes region-specific congestion indices. Server receives, as input, sensor data from environment information acquisition units, including image frames from cameras and numerical readings from presence or pressure sensors. Server applies image processing and object detection algorithms to each frame to detect movable bodies, users, and static obstacles, and associates each detection with a spatial region in a route network. Server aggregates detections and sensor readings over a time window and performs data computation to calculate, for each region, metrics such as object count, average speed, and occupancy ratio. As output, server writes a congestion degree index per region and per time slot into a congestion table or an in-memory key-value store, and these indices are used as inputs in route optimization and prediction steps.

### Step 3:

Server predicts article inflow and work load using a prediction model.
Server reads, as input, historical article records and environment metrics from storage, including time-stamped inflow counts, destination distributions, congestion indices, and calendar features. Server constructs feature vectors for each time interval by concatenating time features (time of day, day of week, holiday flag), recent inflow values, and recent congestion indices. Server then executes a prediction algorithm, such as a gradient-boosted tree model or a neural network, to compute predicted inflow amounts and work loads for future time intervals. The data processing consists of matrix-vector multiplications and non-linear transformations defined by the trained model parameters. As output, server stores predicted inflow and work load values in a prediction table and supplies these values as inputs to sorting plan generation.

### Step 4:

Server generates a sorting plan for articles.
Server obtains, as input, current article records awaiting processing and prediction outputs indicating expected inflow and work load per region and time. Server builds a list of decision variables representing assignment of articles to sorting destinations and processing times. Server then performs data computation by formulating an optimization problem with an objective function that minimizes total delay, imbalance, and travel distance, subject to capacity constraints of sorting resources. Server calls an optimization solver to compute an optimal or near-optimal assignment. As output, server writes a sorting plan specifying, for each article, a sorting destination, a target handling time interval, and a priority value, and this plan is forwarded to route optimization and movable body control units.

### Step 5:

Server constructs and updates a route network with dynamic costs.
Server reads, as input, a static graph representation of the logistics area, including nodes (positions, intersections, shelves) and edges (traversable paths), and the latest region-specific congestion indices computed in Step 2. Server computes, for each edge, a cost value by combining a base travel time or distance with weighted congestion penalties and safety margins, using predefined weighting rules. This computation applies mathematical operations such as weighted sums and piecewise functions that depend on current time and region. As output, server produces a dynamically updated route network in which each edge has an associated cost value, and this network is used as input to route search algorithms.

### Step 6:

Server computes travel routes for movable bodies.
Server receives, as input, the dynamic route network from Step 5, the sorting plan from Step 4, and current states of movable bodies including positions, battery levels, and task queues. Server groups pending tasks into sequences and, for each movable body, runs a pathfinding algorithm such as Dijkstra or A* on the route network to compute a minimum-cost path between successive waypoints. Server may perform additional data processing to resolve route conflicts by checking for temporal overlaps at nodes and adjusting departure times or alternative paths. As output, server generates, for each movable body, a route plan consisting of an ordered list of nodes, estimated times, and associated tasks, and stores these plans in a route table.

### Step 7:

Server issues high-level control commands to movable bodies.
Server takes, as input, the route plans generated in Step 6 and the current execution state of each movable body. Server transforms each route plan into a set of motion primitives, such as waypoints with coordinates, target velocities, and position tolerances, and into task instructions specifying operations like pick-up and drop-off. Server then performs data formatting to pack these primitives and instructions into control messages compatible with communication protocols used by the terminals mounted on the movable bodies. As output, server transmits the control messages via the network interface, and these messages become inputs to the terminals' local control processes.

### Step 8:

Terminal executes local control and reports status.
Terminal receives, as input, high-level control commands from the server, including waypoints and task instructions. Terminal obtains sensor data, such as distance measurements and odometry, from local sensors. Terminal performs data computation by running localization algorithms and trajectory-tracking controllers, which calculate actuator commands required to move toward the next waypoint while avoiding obstacles detected in sensor data. Terminal also manages internal task states, marking tasks as in progress or completed. As output, terminal sends status updates to the server, including current pose, progress markers, and error codes, which become input to server-side monitoring and re-planning.

### Step 9:

Server monitors execution and adjusts routes in real time.
Server accepts, as input, periodic status messages from terminals, and updated congestion indices from the environment information acquisition unit. Server compares reported positions and progress against expected route plans and deadlines, and detects deviations, delays, or new congestion events. Server performs data computation by recalculating costs in the affected regions and selectively rerunning pathfinding algorithms for impacted movable bodies. When a more favorable route is found, server updates the route plan and generates new motion primitives. As output, server sends updated control messages to the relevant terminals, thereby dynamically adapting physical movements to current conditions.

### Step 10:

Server generates and transmits work instructions to user terminals.
Server takes, as input, the sorting plan, route plans, and abnormality events such as failed sensor reads, blocked paths, or repeated delays. Server identifies situations where human intervention is required, such as manual inspection of problematic articles or removal of obstacles. Server then constructs work instruction records that include a task description, a target location, a priority level, and contextual information. This data processing consists of selecting relevant events, attaching location data, and formatting message content. As output, server sends these work instruction records to user terminals, which display the instructions for users to act upon.

### Step 11:

User performs tasks and submits confirmations and feedback.
User receives, as input, work instructions on a terminal display, including locations, article identifiers, and required actions. User physically moves to indicated locations, performs operations such as scanning an article, inspecting a damaged package, or clearing an aisle, and then enters results into the terminal. Terminal sends, as output, completion confirmations, error notes, and optional comments back to the server. The data includes task IDs, time stamps, and structured or free-form feedback text. These outputs become part of the operation history and evaluation information processed by the server.

### Step 12:

Server records operation history and computes work efficiency indices.
Server receives, as input, execution logs from movable body terminals, user confirmations and feedback, and system events from earlier steps. Server writes these into an operation history table that captures actions, times, locations, and outcomes. Server then computes work efficiency indices such as throughput per region, average task completion time, frequency of route changes, and occurrence rates of errors and delays. This computation involves aggregations, statistical summaries, and, if desired, outlier detection. As output, server stores updated efficiency indices and associated metrics in a performance table, which serve as inputs to feedback analysis and generative AI cooperation.

### Step 13:

Server analyzes feedback and updates operational conditions.
Server takes, as input, evaluation information from users, operation history, and work efficiency indices from Step 12. Server correlates ratings and comments with specific regions, routes, and article categories by joining tables on task IDs, timestamps, and locations. Server performs data computation to identify patterns such as repeated low ratings for certain routes, high delay rates for certain article types, or frequent manual overrides of automatic decisions. Based on these findings, server modifies operational conditions, such as adjusting congestion thresholds, reprioritizing certain article attributes, or changing parameters in cost functions. As output, server writes updated parameters into configuration data structures used by prediction, sorting plan generation, and route optimization units.

### Step 14:

Server constructs prompt sentences for a generative AI model.
Server reads, as input, selected summaries from operation history, prediction errors, congestion metrics, and feedback analysis results. Server formats this data into structured natural language text that highlights key issues, constraints, and performance indicators. Server performs data transformation by converting numerical values and events into context sentences and by organizing information into coherent prompts. For example, server may generate a prompt sentence such as:
“Current warehouse data show repeated congestion in zone B between 16:00 and 18:00, with traversal times 25% higher than other zones and frequent worker complaints about unnecessary stops. The route cost function uses uniform congestion penalties and static speed limits. Suggest modifications to the cost function and routing algorithm to reduce delays while maintaining safety.”
As output, server produces one or more prompt sentences and sends them as textual input to the generative AI model.

### Step 15:

Server receives generative AI responses and extracts configuration proposals.
Server obtains, as input, natural language responses from the generative AI model generated in reply to the prompt sentences from Step 14. Server parses the responses using pattern matching or simple natural language processing to locate explicit recommendations, such as proposed new parameter values, additional features to be used in prediction, or modified rules for priority determination. Server then executes data computation to map textual descriptions into concrete numerical or logical values, for instance by interpreting phrases like “double the congestion penalty in zone B during peak hours” as updated weight coefficients and time intervals. As output, server generates candidate configuration updates and records them in a change proposal table.

### Step 16:

Server applies validated configuration changes to internal modules.
Server reads, as input, candidate configuration updates from the change proposal table and, optionally, constraints or approval flags indicating which updates are allowed. Server validates that new parameter values are within acceptable ranges and that added features are supported by existing data structures. Server then updates internal configuration records used by the prediction unit, sorting plan generation unit, and route optimization unit, such as weight matrices, thresholds, and priority rules. Server may also schedule retraining of prediction models when feature sets change, using stored historical data. As output, server commits the new configuration to persistent storage and activates it for subsequent processing cycles, thereby closing the loop between generative AI suggestions and concrete algorithm behavior.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional parcel locker systems that utilize mobile bodies with autonomous travel capabilities typically optimize locker placement and routing based on static or historical logistics data, such as parcel volume, delivery history, or traffic conditions. In such systems, a server executes route planning and demand prediction by processing tabular data and sensor data in a fixed pipeline. Although this improves utilization of transport resources, the computational workflow is essentially one-way and does not adapt the underlying processing logic in response to real-time user interaction patterns or user states.

In particular, known systems do not treat user emotional state, as inferred from usage behavior or sensor input, as a first-class input to server-side control logic. Emotional signals, if considered at all, are typically analyzed offline for marketing or user research, and are not integrated into the live control loop that governs route optimization, guidance generation, and user option presentation. As a result, the server-side computing stack cannot dynamically reconfigure its models, parameters, or content-generation behavior when user frustration or anxiety increases, even though the underlying hardware and software resources would be capable of such adaptation.
Furthermore, although generative AI models capable of creating natural-language text have become available, they are usually integrated into service systems in a naive fashion. In many existing implementations, a server simply forwards a small set of status fields to a generative model along with a generic instruction, and uses the returned text as-is. The construction of prompt sentences is typically ad hoc, not traceable, and not tightly coupled with system state or performance metrics. Consequently, the generative AI model operates as a black-box text generator rather than as an integrated component of the control architecture. This limits the ability of the system to systematically improve the quality and relevance of generated guidance, and makes it difficult to ensure consistency, robustness, and safety of outputs across diverse user states.
Additionally, known systems rarely close the loop between user feedback, emotional inference, and generative prompt design. Feedback data (such as ratings or comments) may be stored, but they are not systematically linked with the precise prompts used, the emotional states inferred at the time of interaction, and the resulting behavioral outcomes (such as successful pickup or redelivery). As a result, the system cannot effectively use accumulated interaction data to improve the classification models, the control parameters, or the generation templates, and therefore cannot achieve a continuous, data-driven improvement of the computing process itself.
Accordingly, there is a need for a system architecture in which a processor executes a coordinated sequence of operations that (i) estimates a user's emotional state based on multi-modal input from a portable terminal device, (ii) adjusts route optimization and guidance generation logic in real time based on that emotional state, (iii) programmatically constructs structured prompt sentences for a generative AI model using a rich context object derived from system state, and (iv) uses feedback and outcome data to update both the emotion estimation models and the prompt construction logic. By realizing such an architecture, the invention aims to improve the functioning of the computer system itself: the server-side processing pipeline becomes adaptive to user state, the integration with the generative AI model becomes structured and auditable, and the overall system can more efficiently compute routes and generate guidance that better match user needs and reduce user confusion or dissatisfaction.

The specific processing by the specific processing unit 290 of the data processing device 12 in Example 2 is realized by the following means.

The present invention provides a server comprising a processor and a memory storing instructions that, when executed by the processor, cause the processor to perform operations including: acquiring, via a communication interface, location information of a user and historical information related to parcel delivery demand from one or more client devices and external data sources; generating candidate placement locations and travel routes for a mobile body equipped with an autonomous travel function and a parcel storage mechanism based on the acquired information; analyzing the acquired location information and the historical information related to parcel delivery demand to calculate an evaluation value for optimizing the placement locations and the travel routes of the mobile body, and determining stop positions, stop durations, and travel paths of the mobile body; acquiring operation information from a portable terminal device and detection information from one or more sensors of the portable terminal device, and estimating, by executing an emotion classification model, an emotional state representing a psychological state of the user based on the operation information and the detection information; modifying, in accordance with the estimated emotional state, at least one of demand prediction conditions used in the analysis, the travel route of the mobile body, the stop duration of the mobile body, and guidance conditions for presenting information to the user; generating, by executing a prompt generation module, a prompt sentence comprising at least one of an instruction sentence, a condition description, and a situation description, based on at least the emotional state of the user, the location information of the user, reservation information related to use of the parcel storage mechanism, and operation information of the mobile body, the prompt sentence being configured as input to a generative AI model that probabilistically generates text data; transmitting the generated prompt sentence to the generative AI model via an application programming interface, obtaining a natural language text output from the generative AI model, and generating, based on the natural language text output, guidance information or response information to be presented to the user on the portable terminal device; transmitting and receiving, to and from the portable terminal device, at least the guidance information or the response information, location information of the mobile body, a predicted arrival time of the mobile body, and information on available service options, and accepting, from the user via the portable terminal device, at least one of a service use reservation, a redelivery request, and a support request; in response to a received redelivery request, recalculating, by executing a route optimization module, the travel route of the mobile body and outputting updated route information to the mobile body, and in response to a received support request, outputting support instruction information including at least the emotional state of the user and a usage situation of the user to a support-side terminal; and storing evaluation information and free-description information acquired from the user in association with at least the emotional state and the guidance information or the response information presented to the user, and generating learning data based on accumulated information so as to update at least classification processing for the emotional state and template selection conditions for generating the prompt sentence. This enables the computer system to dynamically couple emotion-aware control logic with route optimization and generative text generation, to adapt internal processing parameters and prompt construction to real-time user state, and to iteratively improve both the emotion estimation models and the prompt generation logic based on logged interactions, thereby enhancing the technical performance and robustness of the underlying server-side computing processes.

The term “system” refers to an arrangement of one or more information processing apparatuses, one or more mobile bodies, one or more storage mechanisms for parcels, and one or more communication devices that cooperate to provide parcel-related services under control of at least one processor.

The term “processor” refers to a hardware computation unit, such as a central processing unit or a specialized processing circuit, that executes instructions stored in a memory to perform data processing, control, and communication operations.
The term “memory” refers to a hardware storage medium, such as a volatile or non-volatile storage device, that stores instructions and data for use by a processor.
The term “mobile body” refers to a movable apparatus, such as an autonomously traveling vehicle or robot, that is configured to travel within a service area while carrying a parcel storage mechanism.
The term “autonomous travel function” refers to a function that allows a mobile body to move along a route without continuous human operation, based on sensor information, map information, and control algorithms executed by one or more processors.
The term “parcel storage mechanism” refers to a storage structure having at least one compartment configured to hold a parcel and to allow a user to deposit or retrieve the parcel by performing an authentication or other operation.
The term “user” refers to a human individual who uses the system to receive or send a parcel, or to request a parcel-related service via a client device.
The term “portable terminal device” refers to a movable information processing device, such as a smartphone or a tablet, having at least a display, an input interface, and a communication interface for communicating with a server.
The term “location information” refers to information indicating a geographic position, such as coordinates, area identifiers, or similar positional data obtained from sensors or external services.
The term “historical information related to parcel delivery demand” refers to data representing past parcel-related events, including at least one of delivery times, pickup times, locations, parcel counts, redelivery counts, or reservation counts.
The term “operation information” refers to information indicating user interactions with a user interface, including at least one of touch events, button activations, text input events, navigation events, and error events.
The term “detection information” refers to information obtained from one or more sensors of a portable terminal device, including at least one of position sensor output, image sensor output, audio sensor output, motion sensor output, or similar sensor output.
The term “sensor” refers to a hardware component that measures a physical quantity or environmental condition and outputs a corresponding electrical or digital signal, including at least cameras, microphones, position sensors, and motion sensors.
The term “emotional state” refers to information representing a psychological condition of a user, expressed as one or more labels or numerical values indicating levels of states such as relief, anxiety, irritation, or satisfaction.
The term “emotion classification model” refers to a trained information processing model, such as a machine learning model, that receives operation information and detection information as input and outputs an estimated emotional state.
The term “guidance information” refers to information presented to a user to assist with parcel-related actions, including at least one of text descriptions, timing information, location indications, and service option descriptions.
The term “response information” refers to information presented to a user in response to a detected situation or user request, including at least apologies, explanations, and instructions.
The term “reservation information” refers to information indicating a user's planned use of a parcel service, including at least one of a scheduled time, a location, a parcel identifier, and a selected service type.
The term “operation information of the mobile body” refers to information indicating a status or plan of a mobile body, including at least a current position, a route, a predicted arrival time, and a stop duration.
The term “demand prediction conditions” refers to parameters or settings used by a processor when executing an algorithm that predicts future parcel delivery demand based on historical and current data.
The term “guidance conditions” refers to control parameters or rules that determine content, tone, timing, or presentation style of information displayed to a user.
The term “prompt sentence” refers to a text sequence comprising at least one of an instruction, a condition description, and a situation description, configured to be input to a generative AI model so as to induce a desired type of output.
The term “generative AI model” refers to an information processing model trained using data-driven techniques, such as deep learning, that receives input data including a prompt sentence and probabilistically generates new text data as output.
The term “natural language text output” refers to text generated by a generative AI model in a human language, such as sentences or paragraphs suitable for direct presentation to a user.
The term “application programming interface” refers to a defined interface, such as a network-based API, that specifies how software components or services communicate and exchange data using structured requests and responses.
The term “service use reservation” refers to a request from a user to use a parcel-related service at a specified time and place, including at least parcel pickup or shipment.
The term “redelivery request” refers to a request from a user to change a delivery plan so that a parcel is delivered again, for example to a different time slot or location.
The term “support request” refers to a request from a user seeking assistance, including at least technical support, operation guidance, or problem resolution.
The term “support-side terminal” refers to an information processing device used by support personnel to view user information, emotional states, and context, and to provide responses or take actions in the system.
The term “route optimization module” refers to a software component executed by a processor to compute or recompute travel routes, stop positions, and stop durations of one or more mobile bodies under constraints.
The term “evaluation value” refers to a numerical or structured indicator calculated by the processor to measure quality or suitability of candidate placement locations or travel routes for mobile bodies.
The term “stop position” refers to a location at which a mobile body is planned or instructed to remain stationary for a predetermined time period.
The term “stop duration” refers to a length of time during which a mobile body is planned or instructed to remain at a stop position.
The term “travel path” refers to a sequence of positions or segments representing a route to be traveled by a mobile body between locations.
The term “available service options” refers to selectable alternatives offered to a user, including at least pickup at a locker, delivery to a specified address, reservation change, and contact with support personnel.
The term “evaluation information” refers to feedback data supplied by a user, including at least rating scores, selection of options, and results of service use.
The term “free-description information” refers to user-provided text comments or similar unstructured input expressing opinions or experiences regarding the service.
The term “learning data” refers to data prepared for use in training or updating an information processing model, including at least input features, target labels, and associated metadata.
The term “template selection conditions” refers to rules or criteria used by the processor to select one template among multiple prompt templates based on context information such as emotional state, delay status, or user attributes.

In the following embodiments, “server” denotes an information processing apparatus including at least one processor and at least one memory, “terminal” denotes a portable terminal device such as a smartphone or tablet operated by a user, and “user” denotes a human individual utilizing parcel services provided via the system.

Server implements the claimed functions by executing one or more server programs on general-purpose server hardware. Server, in one embodiment, includes a multi-core central processing unit, a main memory, a non-volatile storage device, and a network interface card connected to a communication network. Server executes an operating system such as a server-class operating system and executes an application framework such as a web framework on top of the operating system. Server further executes auxiliary software modules such as a web server for terminating encrypted communication, an application server for routing requests to the application framework, and a database management system for persistent storage. Terminal implements user-facing functions by executing a dedicated application on a mobile operating system such as a mobile OS. Terminal includes a processor, a memory, a display unit, an input interface such as a capacitive touch panel, one or more sensors including an image sensor, an audio sensor, and a motion sensor, and a wireless communication interface. Terminal executes APIs provided by the mobile operating system, such as a location API, camera API, audio recording API, and user interface framework, in order to acquire sensor signals and user operation events and to present guidance information to the user.
User operates the terminal to reserve parcel pickup or shipment, to view locker locations, to select redelivery or support, and to provide feedback. User is not required to understand the internal computing procedures of the system and interacts only through the user interface presented by terminal.
Server executes a program module referred to as a data collection module. Server, under control of this module, acquires location information and historical information related to parcel delivery demand. Server receives user location information from terminal via an encrypted transport protocol in the form of structured messages containing latitude-longitude coordinates, area identifiers, and timestamps. Server further receives delivery history information from external logistics systems via application programming interfaces or scheduled data transfer, including past delivery timestamps, pickup timestamps, locations, parcel counts, and redelivery counts. Server stores these datasets in relational tables managed by the database management system. Each record is keyed by user identifier, area identifier, and time, and includes fields such as parcel count, delay time, and service type. Server thereby maintains a structured representation of parcel demand across areas and time periods. Server executes an analysis module for optimizing placement locations and travel routes of mobile bodies. Server uses numerical computation libraries to load relevant subsets of historical records from the database into in-memory data structures such as matrices or tensors. Server constructs input vectors containing features such as area ID (embedded as an index or code), time-of-day, day-of-week, recent parcel counts, and public transport utilization indicators. Server then applies a demand prediction model implemented as a neural network, such as a feedforward network with multiple hidden layers or a recurrent neural network, to compute predicted parcel demand values for each candidate area and time window. Server uses these predicted values, in combination with constraints on fleet size and travel times, as inputs to a route optimization algorithm. Server in one embodiment uses an optimization library based on integer linear programming or constraint programming, in which route candidate variables correspond to sequences of stop positions for each mobile body. Server computes an evaluation value for each candidate route by summing weighted terms such as predicted service level, travel distance, and expected waiting time. Server then selects optimal routes that minimize or maximize the evaluation value according to design criteria.
Terminal executes an emotion estimation module on-device. Terminal acquires operation information by registering event listeners in the user interface framework. Terminal records user tap events, swipe events, long-press events, text input events, and screen transition events. Terminal converts these events into numerical features such as tap frequency per unit time, average interval between taps, error count per screen, and number of back-and-forth navigation steps. Terminal acquires detection information from sensors by periodically invoking the camera API and audio recording API when the user has granted permission. Terminal captures small image patches containing the user's face and short audio segments of the user's voice.
Terminal preprocesses the image signals using an image processing library. Terminal detects face regions and extracts facial landmark points, such as coordinates of the eyes, eyebrows, nose, and mouth. Terminal normalizes the landmark positions by dividing by face bounding-box dimensions to achieve invariance to absolute size. Terminal converts the normalized coordinates into a fixed-length feature vector. Terminal likewise preprocesses the audio signals using a digital signal processing library. Terminal splits audio into frames and computes spectral features such as Mel-frequency cepstral coefficients, spectral centroid, energy, pitch, and pitch variance. Terminal aggregates these features over the analysis window into a fixed-length vector, for example by averaging or pooling.
Terminal concatenates the operation features, facial features, and audio features into a unified feature vector. Terminal inputs this vector into an emotion classification model stored as a compact neural network model file, such as a model using a small number of fully connected layers with rectified linear unit activation and a softmax output layer. Terminal performs inference by loading model weights into memory and executing the defined matrix multiplications and nonlinear transformations. Terminal obtains a set of output values representing probabilities for discrete emotional states such as “relief,” “anxiety,” “irritation,” and “satisfaction.” Terminal applies a temporal smoothing filter, such as an exponential moving average over successive windows, to the probabilities to reduce spurious fluctuations caused by noise.
Terminal in this way computes an emotional state that is not simply declared based on static rules but is produced by a learned mapping from high-dimensional sensor and operation features to emotion labels. This mapping is performed at a speed and complexity that cannot be achieved by a human in real time and uses internal model parameters optimized through training on large datasets of labeled interaction examples. Terminal transmits the smoothed emotion label, the associated confidence value, the current location information, the current screen type, and selected usage statistics to server in a structured format.
Server receives these emotion-related updates and executes an emotion-aware control module. Server aggregates temporal sequences of emotion labels for each user and uses analytics functions to compute measures such as the duration of sustained negative emotion, the frequency of emotion transitions, and correlations between emotion and waiting time. Server maintains an in-memory context object for each active user session, including fields such as current emotional state, emotional trend, reservation information, predicted arrival time of the assigned mobile body, measured delay, and estimated walking time between the user and the mobile body.
Server uses this context object in a route adjustment algorithm. Server extends the evaluation value used by the route optimization module to include terms that reflect emotional load. For example, server increases the penalty associated with leaving high-anxiety users waiting, and reduces the penalty associated with slight increases in travel distance to assist such users. Server adjusts constraints on stop duration and priority for certain stops based on aggregated emotional states in each area. Thus, server modifies the solutions of the route optimization algorithm by introducing emotion-dependent coefficients and constraints, thereby altering the computation performed by the underlying optimization engine. This modification changes not only output routes but also internal search paths and pruning conditions of the solver, leading to different memory access patterns and convergence behaviors compared to a system that does not incorporate emotional state. Consequently, the system improves technical performance metrics such as fairness of service distribution under constraints and overall waiting time variance.
Server also executes a prompt generation module to construct structured prompt sentences for a generative AI model. Server stores templates of prompt sentences in a template repository, each template including placeholders for variables such as emotional state, delay duration, walking time, user attribute flags, and current screen type. Server uses the context object as input to a decision procedure that selects one template among a plurality of templates. This decision procedure can be implemented as a rule engine or as a machine learning classifier that outputs a template identifier in response to feature vectors derived from the context. Server fills the placeholders of the selected template with concrete values. For example, server calculates an integer delay in minutes and integrates this value into a sentence describing the delay; server estimates walking time in minutes and incorporates that into a sentence describing distance. Server thereby generates a prompt sentence configured for input to a generative AI model. An example of such a prompt sentence for an anxious elderly user is as follows:
“You are a customer support staff member for a parcel delivery service.
Please create a Japanese guidance message that gives a sense of security to the following user.

### Conditions:

The user is an elderly person.
The user is unfamiliar with smartphone operation and feels anxious.
The walking distance from the user's home to the parcel locker vehicle is about 3 minutes.
The parcel locker vehicle will remain parked at that location until 18:00 today.

### Content:

The location of the locker
By when the user should arrive
How the user can get support if the operation is difficult
   Please explain these points in 3-5 sentences, using polite and gentle Japanese.”
   Another example of a prompt sentence for an irritated user facing a delay is as follows:
   “You are a customer support staff member for a parcel delivery service.
   Please create an apology message in Japanese for the following situation.

### Situation:

The user feels irritated about receiving the parcel.
The autonomous locker vehicle's arrival is delayed by 30 minutes from the scheduled time.
After arriving at the current location, the locker vehicle will stay there for another 15 minutes.
The user can choose either pickup at the locker or redelivery to their home.

### Content:

An apology for the delay
A brief explanation of the current situation
Guidance on the options the user can choose
A considerate sentence that acknowledges the user's irritation
   Please include all of these items.”
   Server sends the constructed prompt sentence to a generative AI model via an application programming interface. In one embodiment, the generative AI model is a transformer-based language model hosted as a remote service. Server constructs a request message containing the prompt sentence, a model identifier, and generation parameters such as maximum token length and temperature. Server transmits this request over a secure connection and receives a response containing one or more generated texts.
   Server processes the generated text by removing extraneous markers and formatting line breaks according to rules suitable for display on mobile screens. Server may also apply post-processing filters that check for prohibited content or inconsistent instructions, using pattern matching or secondary classifiers. Server then stores the final guidance text in association with the prompt sentence and the context object used to generate it.
   Terminal receives the guidance text and associated structured data such as mobile body location, predicted arrival time, and available options. Terminal updates its user interface to show the guidance message, a map with the mobile body's position, and action buttons for operations such as “request redelivery” or “contact support.” The guidance message is thus not directly generated at the terminal but is the result of server-side prompt construction and generative model execution, reflecting the real-time emotional and logistical state. User interacts with these options. If user selects redelivery, terminal sends a request containing the user identifier, current location, and selected option. Server receives this request and invokes the route optimization module. Server adds the user's home location as an additional potential stop into the route optimization model, recalculates travel paths using current fleet positions, and updates the plan for one or more mobile bodies. Server transmits the new route data to the mobile body via a communication interface.
   The mobile body in this embodiment includes onboard controllers that execute a motion planning stack such as an autonomous driving framework. The onboard controller converts the updated route data into waypoints and time windows and uses sensor input from position sensors, environment sensors, and obstacle detection sensors to follow the waypoints. The connection between server-side route update and onboard execution is realized through data messages that change the target paths used by the control algorithms. Thus, the algorithmic decisions made by server directly affect physical movement in the real world, such as steering angles, acceleration profiles, and timing of stops.
   Server further executes a learning data generation module. Server records, in the database, user evaluation information such as scores, binary satisfaction flags, and free-description comments. Server links these records with the corresponding emotional states, guidance texts, and prompt sentences, and with service outcomes such as successful or failed parcel pickup. Server processes the free-description comments using a natural language processing library, extracting sentiment scores and key phrases. Server constructs training samples in which the input features include operation information, detection information, context features such as delay duration and walking time, and the target labels include emotion labels and satisfaction-level indicators.
   Server trains or fine-tunes emotion classification models and prompt template selection models using such training samples. Server uses supervised learning procedures with loss functions such as cross-entropy for classification tasks. Server updates model weights using optimization algorithms such as stochastic gradient descent or adaptive gradient methods. Server may augment the training data by applying techniques such as noise injection into sensor features or synthetic delay scenarios to improve robustness. After training, server compresses model parameters and converts them into formats optimized for mobile inference such as small-footprint neural network formats, and distributes updated models to terminals. By structuring the system in this way, server, terminal, and user cooperate to realize a computing architecture that improves technical performance beyond mere automation of human tasks. For emotion estimation, terminal aggregates multi-modal high-dimensional features and runs compact neural networks optimized for resource-constrained devices, reducing network traffic and server load, which increases scalability and reduces latency. For route planning, server integrates emotional weighting into the optimization objective, which is a computational operation not performed by human operators and results in quantitative improvements in metrics such as average waiting time and standard deviation of waiting time across users. For guidance generation, server uses structured prompt sentences that encode system state in a machine-consumable yet human-descriptive form, ensuring reproducible, auditable interaction with the generative AI model and enabling systematic refinement based on feedback.
   This architecture improves computer technology itself by enabling dynamic reconfiguration of prediction and optimization modules in response to user-generated signals; by structuring prompt generation as a formal computing step that manipulates context-based templates and parameters rather than using arbitrary free-form text; by using learned models to transform raw sensor data into useful labels under complexity and time constraints beyond human ability; and by closing the loop between logged interactions and model updates in a controlled, machine-executable process. The system thus yields technical effects such as higher accuracy in emotion classification, more efficient routing with reduced computational search space through the use of informed emotional constraints, reduced communication load through on-device processing, and more relevant natural-language guidance with lower need for manual intervention.
   In alternative embodiments, server may offload portions of the emotion estimation to server-side models when terminal resources are limited, by transmitting feature vectors rather than raw sensor data, which still reduces bandwidth and preserves privacy. Server may also implement different neural architectures, such as convolutional neural networks for facial feature extraction or transformer encoders for sequential operation features. Terminal may present guidance in multimodal forms, such as synthesized speech, to correspond to different user needs. The fundamental structure, however, remains that server generates and uses context-dependent prompt sentences for a generative AI model, integrates emotion-aware control into route computation, and leverages accumulated interaction data to iteratively improve internal models and templates, all under concrete data structures and algorithmic flows executed by computing hardware.

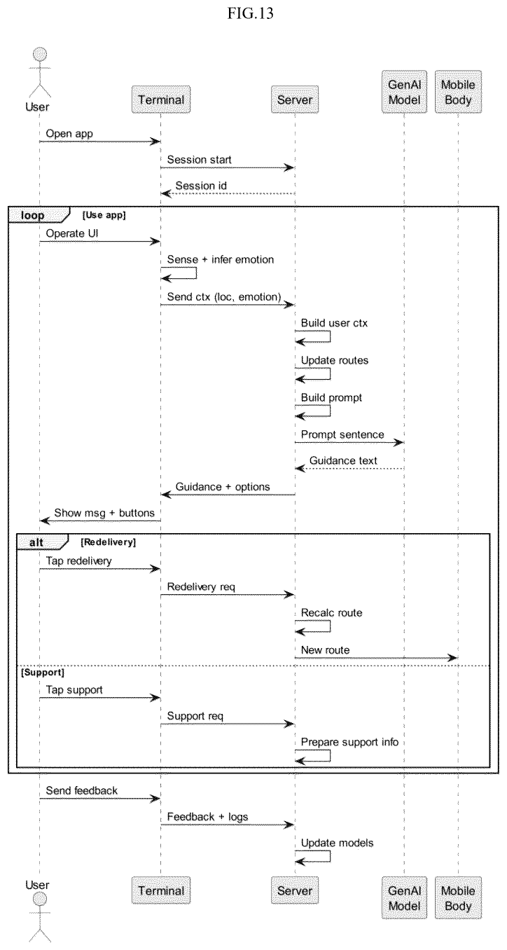

The following describes the processing flow using FIG. 13.

### Step 1:

Terminal starts a locker application and initializes a user session.
Terminal receives as input a user action of launching the application, a stored user identifier, a device identifier, and an initial configuration file. Terminal calls a location API to obtain latitude and longitude and optionally calls a reverse-geocoding service to obtain an area identifier. Terminal constructs a data structure that includes the user identifier, device identifier, location, timestamp, and application version. Terminal performs serialization of this structure into a message format and transmits the message to server via an encrypted channel. The output of this step is an initial session-start request containing identification and location data.
Server receives the session-start request and validates the payload. Server takes as input the serialized message from terminal, parses the JSON or similar structure into internal variables, and checks required fields and formats. Server generates a new session identifier, performs a write operation to a persistent data store to register the session, and creates an in-memory record for fast access. The output of this processing is a session record stored in a database and a response message containing the session identifier and initial configuration parameters. User observes that the application has moved from a splash screen to a home screen indicating that the system is ready for service operations.

### Step 2:

Terminal begins capturing user operation information and sensor data.
Terminal receives as input real-time touch events (taps, swipes, long presses), text input events, and screen transition events provided by the user via the user interface framework, as well as raw signals from sensors such as a camera and microphone when permissions are granted. Terminal records for each event a timestamp, event type, target component ID, and coordinates. Terminal aggregates these records into short time windows and computes statistics such as tap count, average tap interval, error count per form, and number of screen transitions. For sensor data, terminal calls camera APIs to capture small image frames and audio APIs to record audio segments. Terminal stores these raw buffers in short-lived memory structures. The output of this step is a set of buffered operation logs and raw sensor samples associated with time windows.
User interacts with the application in a natural manner, such as scrolling through a list of lockers or inputting a reservation time, thereby generating the operation information and sensor inputs that terminal collects.

### Step 3:

Terminal converts raw sensor signals and operation logs into numerical feature vectors. Terminal receives as input the buffered operation logs and raw sensor samples from Step 2. Terminal executes an image-processing routine to detect a face region, computes facial landmarks (for example, eye and mouth positions), normalizes the coordinates, and flattens them into a fixed-length vector. Terminal executes an audio-processing routine that segments the audio into frames, computes spectral features such as Mel-frequency cepstral coefficients, energy, and pitch, and aggregates these into another fixed-length vector. Terminal transforms operation logs into numerical features such as tap frequency, mean response time, and number of input corrections. Terminal concatenates these face features, audio features, and operation features into a unified feature vector. The output of this step is a combined feature vector representing the user state in a given time window.
User continues operating the application, unaware that these transformations are occurring in the background on terminal.

### Step 4:

Terminal estimates the user's emotional state using an on-device model.
Terminal receives as input the combined feature vector from Step 3 and a preloaded emotion classification model. Terminal maps the feature vector into the model's input tensor and performs a sequence of matrix multiplications and non-linear activations defined by the model architecture. Terminal calculates logits for each emotion label, applies a normalization function such as softmax to obtain probabilities, and selects the label with the highest probability as the primary emotional state. Terminal further applies a temporal smoothing algorithm, using probabilities from multiple consecutive windows, to reduce noise in the result. The data-processing operation in this step transforms high-dimensional feature vectors into a single emotion label and an associated confidence score. The output of this step is an emotion state record that includes label, confidence, and timestamp.
User's emotional condition, such as anxiety due to uncertainty about locker location, is thus transformed into a machine-usable representation through this numerical inference process.

### Step 5:

Terminal transmits updated emotional state and context to server.
Terminal receives as input the emotion state record from Step 4, the current location of the device, the current screen type, and recent operation statistics. Terminal constructs a context message including the emotion label, confidence value, coordinates or area identifier, screen identifier, and error counts, and associates it with the session identifier. Terminal serializes this compound structure into a message format and sends it over the network to a designated endpoint on server. The output of this step is a context update message that encapsulates the user's emotional state and interaction status.
Server receives the context update message and performs parsing and validation. Server writes the emotion data and associated context fields into a logging table or structure in persistent storage and updates an in-memory map keyed by session identifier to retain only the most recent emotional state. The output generated by server is an updated context store that can be accessed by subsequent control logic.

### Step 6:

Server synthesizes a user context object for control and guidance.
Server takes as input the latest context update from Step 5, historical emotion logs for the same user, reservation information, mobile body status data, and previously stored parcel demand data. Server executes query operations on the database to retrieve recent emotion log entries and reservation records and pulls mobile body positions and schedules from a fleet management table. Server computes secondary indicators, such as the duration for which negative emotional states have persisted and the difference between scheduled and predicted arrival times, by simple arithmetic and time-difference operations. Server estimates walking time from the user's last known location to the mobile body using precomputed or dynamically computed path length and average walking speed. These data-processing operations transform raw log entries and positional records into a structured context object containing fields such as current emotion, trend, delay, walking time, and user attributes. The output of this step is the user context object in an internal representation.
User's situational state, including both psychological and logistical aspects, is now represented as a unified data structure that can be used by server decision algorithms.

### Step 7:

Server adjusts route optimization parameters using emotional context.
Server takes as input the user context object from Step 6 and pending route optimization variables for one or more mobile bodies. Server modifies weights or coefficients in an objective function used by the route optimization algorithm, such as increasing penalties for leaving users with persistent anxiety unserved and adjusting constraints on stop durations in areas with high emotional stress. Server then executes an optimization routine, which may be an integer programming solver or a heuristic search, to recompute a set of routes that minimize the revised objective function. The computational operation in this step changes the search space and convergence behavior of the optimizer by introducing emotion-based terms. The output of this step is an updated set of routes, stop positions, and stop durations that reflect both parcel demand and emotional conditions.
User's emotional state thus influences concrete technical outcomes such as the planned sequence of physical stops by mobile bodies, not merely a superficial user interface choice.

### Step 8:

Server constructs a prompt sentence for a generative AI model based on context.
Server receives as input the user context object from Step 6, including emotional state, delay information, walking time, user attributes, screen type, and reservation status. Server executes a template-selection procedure that compares context fields against rules or model outputs to choose one template from a plurality of stored templates for prompt generation. Server fills placeholders in the chosen template with specific values from the context, such as replacing generic time markers with actual minutes of delay or inserting a concrete description of available options. This operation transforms structured context data into a linear text sequence that embeds both conditions and content requirements. An example prompt sentence generated in this step is:
“You are a customer support staff member for a parcel delivery service.
Please create a Japanese guidance message that gives a sense of security to the following user.

### Conditions:

The user is an elderly person.
The user is unfamiliar with smartphone operation and feels anxious.
The walking distance from the user's home to the parcel locker vehicle is about 3 minutes.
The parcel locker vehicle will remain parked at that location until 18:00 today.

### Content:

The location of the locker
By when the user should arrive
How the user can get support if the operation is difficult
   Please explain these points in 3-5 sentences, using polite and gentle Japanese.” The output of this step is a prompt sentence text that is formatted for direct use as input to a generative AI model.

### Step 9:

Server interacts with the generative AI model to obtain guidance text.
Server receives as input the prompt sentence from Step 8 and predefined generation parameters such as maximum token length, temperature, and top-p values. Server constructs a request payload including the prompt sentence and parameters, serializes it, and transmits it to a generative AI model endpoint using an application programming interface. The generative AI model, hosted on a computing platform, processes the prompt via a transformer architecture that applies attention and decoding operations to generate a response. Server receives the response payload, parses out the natural language text, and applies post-processing such as whitespace trimming, removal of control tokens, and adjustment of line breaks to fit mobile display constraints. The output of this step is a finalized guidance or response text tailored to the user's context.
User does not directly see the prompt sentence or the intermediate model outputs but will subsequently view the processed guidance text on terminal.

### Step 10:

Server packages guidance and operational data and sends them to terminal.
Server takes as input the finalized guidance text from Step 9, current mobile body location and predicted arrival time from the fleet management module, and a list of available service options determined by business rules and current system state. Server constructs a response object containing the guidance text, coordinates or map identifiers for the locker location, time values indicating arrival or parking end, and flags indicating which actions (such as redelivery request or support contact) should be presented. Server serializes this object into a message and sends it to terminal through the established communication channel. The output of this step is a comprehensive guidance message transmitted to terminal, integrating natural language output with structured logistics data.
User is thus prepared to receive personalized and context-aware information that can assist in making service choices.

### Step 11:

Terminal updates the user interface and accepts user decisions.
Terminal receives as input the guidance message and associated logistics data from Step 10. Terminal updates screen components by placing the guidance text into text display areas, rendering a map view centered on the mobile body location, and enabling or disabling buttons according to the provided action flags. Terminal performs layout calculations to fit text and controls onto the device display and registers event handlers for newly enabled buttons. The output of this step is a refreshed interface state shown to user, in which the available choices correspond to the system's current operational state.
User reads the guidance message and may decide, for example, to walk to the locker, to request redelivery to the home, or to contact support personnel by pressing the appropriate button.

### Step 12:

Terminal transmits user-selected service requests; server modifies routes or support flows.
Terminal takes as input the user's selection, such as a tap on a “request redelivery” or “contact support” button. Terminal constructs a request payload including the user identifier, session identifier, selection type, and current location. Terminal transmits this payload to server. The output of terminal processing is a structured service request message.
Server receives this service request and branches processing based on the selection type. For a redelivery request, server retrieves the user's registered address and relevant constraints from the database, inserts this address as a candidate stop into the route optimization model, and executes optimization routines to recalculate a route that accommodates the new stop. Server then sends updated route commands to the appropriate mobile body. For a support request, server generates a support context bundle containing user identifier, emotional state, and current situation, and forwards this to a support terminal. The output of server processing is either an updated set of route instructions dispatched to a mobile body or a support session initiation presented to a support operator.
User's decision therefore results in concrete modifications to control flows in the system, influencing both physical movements of mobile bodies and allocation of human support resources.

### Step 13:

Server collects feedback and generates learning data for model updates.
User, after the service concludes, inputs feedback via the terminal application, such as rating scores and free-text comments about the experience. Terminal takes this feedback as input, packages it with identifiers of the session, the guidance messages shown, and the last known emotional state, and sends it to server. Server receives this package and stores it in feedback tables. Server loads this and associated emotion and guidance records, computes sentiment scores for the comments using a separate text-analysis model, and labels each interaction instance with outcomes such as successful pickup or cancellation. Server aggregates these instances into datasets with input features including operation statistics and context fields and target labels including emotional state and satisfaction metrics. The data-processing in this step transforms scattered feedback entries and logs into structured training samples. The output of this step is a learning dataset that can be used to retrain or fine-tune both the emotion estimation model and the prompt template selection logic.
User's feedback thereby becomes a direct input into iterative improvement of the computational models, enabling better emotion recognition and more effective prompt sentence selection and generation in subsequent interactions.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional item-handling and delivery systems that employ autonomous mobile devices and distributed storage equipment have primarily optimized physical logistics parameters, such as travel routes, storage locations, and time windows for arrival and departure. These systems typically rely on static optimization engines that process environment information and demand information, and then output fixed control plans. However, such architectures present several technical problems in terms of computer technology.

First, existing control systems do not integrate fine-grained user interaction data and user state data into the core control loop. Terminals used by users generally collect only minimal input (for example, reservation data and authentication information), and ignore rich behavioral signals such as operation history, help usage patterns, and implicit feedback. As a result, processing on the server side cannot adapt its control strategies or interface behavior based on the user's real-time cognitive load, stress, or confusion. From the perspective of computer technology, this leads to suboptimal use of processing resources, since the system is unable to prioritize computation or tailor content in a way that mitigates error-prone interactions and repeated processing.
Second, known systems do not exploit generative AI models in a structured manner within the control pipeline. Even when a generative AI model is used, its input is often a static, manually-designed prompt sentence that does not reflect current environment information, demand information, or quantified emotion indices. Consequently, the generative AI model generates generic control information or support information that may not be consistent with current system constraints or user states. This disconnect results in an inefficient computational pipeline: the model's output requires significant post-processing, or in many cases, is not suitable for direct translation into machine-executable control information, thereby increasing server load and latency without a corresponding improvement in control quality.
Third, typical user interfaces on portable terminals operate in a static display mode, independent of dynamic user states estimated from multimodal data such as facial expressions, speech characteristics, and operation logs. Without a feedback loop from server-side emotion estimation back into the user interface layer, the system continues to present the same density and style of information even when the user is stressed or confused. This produces more input errors, more help requests, and longer task completion times, which in turn generate additional network traffic and redundant processing on the server. From a computer-technical viewpoint, this behavior represents inefficiency in human-computer interaction, because the system lacks mechanisms to dynamically reduce interface complexity and adapt information presentation based on objective metrics.
Fourth, conventional architectures typically do not maintain a structured correspondence between emotion indices, generated control information, operation histories, and user feedback for learning purposes. Log data are often stored in isolated formats, making it difficult to systematically generate learning data that can be used to refine prompt sentence generation, improve parameterization of generative AI model calls, or retrain emotion estimation models. This limits the system's ability to improve over time and results in a static control pipeline that cannot progressively reduce computational overhead, error rates, or interaction latency through data-driven refinement.
Accordingly, there is a need for a system and server-side architecture that (i) acquires and processes environment information, demand information, user state information, and user operation information in an integrated manner; (ii) computes emotion indices as first-class control parameters; (iii) dynamically constructs prompt sentences for a generative AI model based on both logistics conditions and emotion indices; (iv) transforms generative outputs into executable control information and adaptive support information; and (v) generates structured learning data linking emotion indices, operation histories, and control information. Such a system should improve the efficiency, robustness, and adaptability of the underlying computer processes themselves, reduce redundant computation and communication, and provide a more reliable and efficient human-computer interaction environment.

The specific processing by the specific processing unit 290 of the data processing device 12 in Application Example 2 is realized by the following means.

The present invention provides a server comprising a processor configured to collect environment information and item-handling demand information related to candidate installation locations for a storage apparatus that performs transfer of items, and user state information and operation information related to a user who utilizes the storage apparatus; analyze the environment information and the item-handling demand information to determine an installation location of the storage apparatus and to generate an optimization policy for a travel route of a mobile apparatus having an autonomous travel function; estimate an emotional state of the user by calculating at least one emotion index on the basis of the user state information and the operation information; generate a prompt sentence for input to a generative AI model on the basis of the item-handling demand information and the emotion index, transmit the prompt sentence to the generative AI model, and acquire, from the generative AI model, control information related to the travel route or operation of the storage apparatus and support information to be presented to the user; determine the travel route and operation parameters of the mobile apparatus on the basis of the control information acquired from the generative AI model, and cause a user terminal to output the support information to the user; record a correspondence among an operation history and feedback information acquired from the user terminal, the emotion index, and the control information, and generate learning data to improve generation of the prompt sentence or determination of the control information; and cause a communication interface to allow the user, via an information processing terminal having at least one of a portable terminal and a display apparatus, to view at least one of a location of the storage apparatus, scheduled arrival information of the mobile apparatus, item transfer procedures, and rest proposal messages, and to reserve receipt and dispatch of an item by operating the information processing terminal. This enables the server to integrate emotion-aware processing into the core control loop, dynamically adapt prompt sentences and generative AI model outputs to current logistics conditions and user states, reduce computational and interaction inefficiencies by tailoring control information and user interfaces to quantified emotion indices, and continuously refine the underlying models and control logic through structured learning data, thereby improving the overall performance and reliability of the computer-implemented logistics control system.

The term “system” refers to an arrangement of one or more information processing devices, storage devices, communication interfaces, and software modules that cooperate to execute logistics control, user interaction, and data processing functions.

The term “server” refers to an information processing device or a group of information processing devices that includes at least one processor, at least one memory, and at least one communication interface, and that executes programs to perform data collection, analysis, emotion estimation, prompt sentence generation, generative AI model interaction, control information generation, and learning data generation.
The term “processor” refers to a hardware computation unit, such as a central processing unit or a processing core, that executes machine-readable instructions to perform arithmetic operations, logical operations, control operations, data input/output operations, and communication operations.
The term “environment information” refers to data representing physical or operational conditions around candidate installation locations for a storage apparatus or around a mobile apparatus, including at least one of position information, traffic condition information, obstacle information, noise level information, and congestion information.
The term “item-handling demand information” refers to data representing requirements or requests related to receipt, dispatch, storage, or transfer of items, including at least one of item quantity, item type, requested delivery time, requested pickup time, and historical usage frequency of a storage apparatus.
The term “storage apparatus” refers to equipment configured to hold, store, or temporarily keep items for receipt or dispatch, including at least one of a locker, a storage container, a cabinet, and a compartment having an openable and closable door or cover.
The term “candidate installation locations” refers to a plurality of possible positions or areas within a service region where the storage apparatus can be placed or stationed, including at least one of roadside areas, building entrances, parking spaces, and indoor areas.
The term “mobile apparatus” refers to a movable equipment unit that is capable of autonomous or semi-autonomous travel, including at least one of a vehicle, a robot, and a transporter, and that is configured to move toward or stay at a location associated with the storage apparatus.
The term “autonomous travel function” refers to a capability of the mobile apparatus to determine or follow a travel route without continuous manual operation, by using at least one of position information, sensor information, and map information to control its motion.
The term “travel route” refers to a sequence of positions, regions, segments, or time-stamped waypoints in a space through which the mobile apparatus moves from a departure position to a destination position.
The term “optimization policy” refers to a set of rules, parameters, or criteria used to compute or adjust the travel route of the mobile apparatus or the installation location of the storage apparatus so as to satisfy at least one performance objective, such as minimizing travel time, reducing energy consumption, or balancing item-handling demand.
The term “user” refers to a person who interacts with the system to request receipt, dispatch, or handling of an item, and who operates a user terminal to view information or input commands.
The term “user state information” refers to data representing a physical, psychological, or behavioral state of the user, including at least one of posture information, facial expression information, voice information, self-reported condition information, and biometric information.
The term “operation information” refers to data representing interactions between the user and a user terminal, including at least one of input event information, touch operation information, button press information, screen transition information, input error information, and help request information.
The term “emotion index” refers to a numeric value or a categorical value that represents an estimated emotional condition of the user, including at least one of a stress level index, a fatigue level index, a confusion level index, a tension level index, and a satisfaction level index.
The term “emotional state” refers to a psychological or physiological condition of the user, including at least one of stress, fatigue, confusion, nervousness, relaxation, and satisfaction.
The term “generative AI model” refers to a machine learning model configured to generate a sequence of data, including at least one of text data and control parameter data, in response to an input, and including at least one of a language model, a sequence-to-sequence model, and a transformer-based model.
The term “prompt sentence” refers to a data string that includes an instruction, condition, question, scenario description, or context information, and that is input to the generative AI model to cause the generative AI model to generate a desired output.
The term “control information” refers to data used to control the behavior of the mobile apparatus or the operation of the storage apparatus, including at least one of route information, speed information, stop position information, timing information, and assignment information.
The term “support information” refers to data to be presented to the user to assist execution of tasks or system usage, including at least one of procedure information, warning information, guidance information, scheduling information, and rest proposal messages.
The term “user terminal” refers to an information processing terminal operated by the user, including at least one of a portable terminal, a smartphone, a tablet terminal, and a display device, and configured to present information to the user and receive input from the user.
The term “information processing terminal” refers to a device that includes at least one processor, at least one display unit, and at least one input unit, and that executes software for communication with the server and for user interaction.
The term “portable terminal” refers to a handheld or body-carried information processing terminal, including at least one of a smartphone, a tablet, a wearable terminal, and a portable computer.
The term “display apparatus” refers to a device including a display unit, such as a liquid crystal display, an organic light emitting display, or an electronic paper display, and configured to visually present information to a user.
The term “operation history” refers to a sequence of records representing user interactions with the user terminal over time, including at least one of tap events, button press events, navigation events, error occurrences, and help activations.
The term “feedback information” refers to explicit or implicit user responses regarding tasks or system behavior, including at least one of rating information, comment information, survey answers, and reaction information.
The term “learning data” refers to data used to train, retrain, or update a model or a rule set, and including at least one of input-output pair records, feature-label pair records, and historical behavior records.
The term “communication interface” refers to a hardware and software combination that enables data exchange between the server and external devices, including at least one of a network interface, a wireless interface, and a communication protocol stack.
The term “scheduled arrival information” refers to time-related data indicating when the mobile apparatus is predicted or planned to arrive at a specific location associated with the storage apparatus.
The term “item transfer procedures” refers to sequential instructions or steps indicating how the user should perform at least one of item receipt, item dispatch, item loading, and item unloading using the storage apparatus.
The term “rest proposal messages” refers to text or other presentation data output to the user to propose that the user take a pause or rest, wherein the content or timing of the messages may be adapted based on the emotion index.
The term “display format” refers to a style or structure for presenting information on a screen of the user terminal, including at least one of text layout, icon arrangement, stepwise segmentation, and emphasis of particular user interface elements.

In one embodiment, a server, a terminal, and a mobile apparatus cooperate to implement the claimed system. The server includes at least one processor, a main memory, a persistent storage device such as a semiconductor memory device or a magnetic disk device, and a network interface. The server executes a general-purpose server operating system such as a UNIX-like operating system, and runs application software including a web server, an application server, a database management system, and machine learning frameworks. The server may employ an image processing library such as a general-purpose image processing library (for example, a library supporting convolution, resizing, normalization, and object detection), a speech processing library such as a general-purpose audio feature extraction library (for example, a library capable of computing mel-frequency cepstral coefficients), and a machine learning framework such as a tensor-based deep learning framework (for example, a framework implementing tensors, automatic differentiation, and neural network layers). The server may also employ a gradient boosting library such as a general-purpose boosting framework and an HTTP client library to access a generative AI model via an application programming interface.

The terminal is configured as an information processing terminal, such as a portable terminal or a display apparatus. The terminal includes a processor, a memory, a display unit such as a touch panel display, an input unit such as a touch sensor or physical buttons, a camera functioning as an imaging apparatus, a microphone functioning as an audio input apparatus, and a wireless communication module. The terminal executes an operating system for portable devices and a client application that communicates with the server using a secure communication protocol such as HTTPS.
The user operates the terminal to interact with the storage apparatus and the server. The user views information such as storage apparatus locations, scheduled arrival information of the mobile apparatus, item transfer procedures, and rest proposal messages, and performs input operations such as selecting a storage apparatus, reserving item receipt or dispatch, and responding to rest proposals.

### Server Configuration for Emotion-Aware Data Processing and Control

The server stores, in the persistent storage device, program modules that realize at least the following logical components: a data collection component, an analysis component, an emotion estimation component, a generative AI cooperation component, a control component, and a learning data generation component. The server configures internal data structures such as relational database tables for environment information, item-handling demand information, storage apparatus information, mobile apparatus information, user profiles, user state information, operation histories, emotion indices, control information, and learning datasets. The server uses the data collection component to acquire environment information and item-handling demand information from external systems, sensors, and management databases. The server, for example, acquires position coordinates, traffic density information, and obstacle information around candidate installation locations for storage apparatuses from sensing devices and geographic information systems. The server acquires item-handling demand information such as item quantities, item categories, requested delivery times, and historical usage frequencies from a logistics management database. The server normalizes these data into structured records, for instance, storing per-location vectors that include counts of incoming and outgoing items per time slot and measured travel times from main traffic routes.
The server uses the data collection component further to receive user state information and operation information from the terminal. The server receives image data captured by the terminal camera, audio data recorded by the terminal microphone, and event logs representing touch operations, button presses, screen transitions, and help activations. The server parses this information into unified data structures that can be processed by the emotion estimation component. For example, the server stores per-session operation histories as sequences of timestamped events with associated screen identifiers and input types.

### Server Configuration for Emotion Estimation

The server employs an emotion estimation component implemented as a set of machine-learned models. In one embodiment, the server uses an image-based model, a speech-based model, an operation-log-based model, and a multimodal fusion model. The server loads each model into memory through the machine learning framework.
The server uses the image processing library to detect a face region in the received image data, for example by applying a trained classifier or a deep convolutional network-based detector. The server crops and resizes the face region to a fixed resolution, converts color channels as required, and normalizes pixel intensities to a predetermined range. The server arranges the normalized image into a tensor and inputs this tensor into a convolutional neural network configured for facial expression classification. The convolutional neural network may include multiple convolution layers, pooling layers, and fully connected layers. The server executes the network in inference mode, and obtains a probability distribution over multiple expression categories such as neutral, positive, and negative expressions. The server computes an image-based emotion feature by aggregating probabilities corresponding to negative expressions, and optionally applies a calibration function to map the raw probabilities to a standardized score.
The server uses the speech processing library to process the audio data. The server resamples the audio to a fixed sampling rate, segments the audio into frames, and computes mel-frequency cepstral coefficients and other prosodic features such as energy, pitch, and speaking rate. The server organizes the features into a time-series matrix and inputs this matrix into a recurrent neural network such as a long short-term memory network. The recurrent neural network processes the sequence of feature vectors and outputs a scalar or vector representing vocal stress or agitation. The server maps this output to a normalized stress feature.
The server uses the gradient boosting library to model patterns in the operation history. The server calculates statistics over operation events, including touch frequency per unit time, number of input errors, number of help invocations, and latency between screen display and user response. The server constructs a feature vector from these statistics and inputs the vector into a gradient boosting model that has been trained to output a confusion score. The server thereby obtains a numeric confusion feature. The server may also incorporate self-reported user state values, such as checkboxes indicating “not tired,” “slightly tired,” or “very tired,” mapped to numeric fatigue values.
The server combines the image-based emotion feature, the vocal stress feature, the confusion feature, and the self-reported fatigue value into a multimodal feature vector. The server inputs this vector into a multimodal neural network composed, for example, of fully connected layers, non-linear activation functions such as rectified linear units, and optional attention mechanisms that weigh the contributions of each modality. The multimodal network outputs multiple emotion indices, such as a stress index, a fatigue index, and a confusion index, each in a continuous range. The server stores these emotion indices in the emotion index table, keyed by user identifier, time, and context (for example, current storage apparatus location or task type).
The server configures the emotion estimation models using training data containing paired inputs and labels. In one embodiment, the server, during a model training phase, uses supervised learning with labeled emotion data gathered from user experiments and historical logs. The server defines a loss function, such as a mean squared error loss for continuous indices or a cross-entropy loss for classification outputs, and updates model parameters using a gradient-based optimization algorithm such as stochastic gradient descent or an adaptive method. The server may apply regularization techniques such as dropout or weight decay, and data augmentation techniques, such as random cropping and color jittering for images, and time-shift and noise addition for audio, to improve model generalization. These details demonstrate that the emotion indices are produced by specific computational transformations in the server, not by an abstract “judgment.”
Server configuration for prompt sentence generation and generative AI cooperation The server employs a generative AI cooperation component. The server uses the database management system to obtain current environment information and item-handling demand information for the storage apparatuses and the mobile apparatuses. The server summarizes, for example, the total number of unprocessed items, the distribution of requested pickup and delivery times, and the current positions and states of mobile apparatuses. The server constructs natural-language descriptions using templates and the summarized values.
The server uses the emotion indices as additional inputs to the prompt sentence generation logic. The server, for example, checks whether the stress index or fatigue index for users associated with a particular storage apparatus location exceeds a threshold. If so, the server generates constraint statements such as “reduce average walking distance,” “limit consecutive handling of heavy items,” and “simplify procedures into few steps.” The server concatenates the logistics summary text and the emotion-based constraints into a prompt sentence in a natural language.
In one example, the server generates the following prompt sentence for the generative AI model:
“Current warehouse status is as follows. The number of unprocessed parcels is 3000, and 10 automated transport devices are active. Shipping deadlines and shelf locations for each parcel are listed below. Based on these conditions, please propose (1) an optimal sorting pattern for the parcels, and (2) an approximate movement plan for the automated transport devices. In addition, workers in a specific area show high stress and fatigue indices and operation errors are increasing. Please ensure that their average walking distance is reduced to less than 80% of the current value, that no worker handles more than three items heavier than 20 kg consecutively, and that each work procedure is split into no more than three concise steps.” The server uses an HTTP client library to send a request to a generative AI model endpoint. The server transmits a message containing at least the model identifier, the above prompt sentence, and generation parameters such as maximum token count and sampling temperature. The generative AI model, implemented for example as a large language model with a transformer architecture, returns a generated text that includes descriptions of sorting rules, movement routes for mobile apparatuses, and user-oriented instructions.
The server parses the generated text into internal representations. For example, the server identifies anchor phrases such as “Sorting Plan:” and “Device Plan:” and splits the text accordingly. The server converts descriptions of item group assignments into structured routing tables and converts descriptions of device paths into sequences of nodes or coordinates. The server extracts the user instruction portions as one or more instruction texts and associates them with relevant user IDs or storage apparatus IDs.
In another example, the server generates a prompt sentence for simplifying an RFID scanning procedure based on a high confusion index:
“The following is an RFID tag scanning procedure: (1) find the target parcel on the shelf, (2) bring the terminal's RFID reader close to the parcel's tag, (3) confirm the ‘scan complete’ message on the screen. Explain this procedure for a beginner worker with high confusion index. Conditions: do not use technical jargon, use no more than three steps, and for each step provide one common mistake and one short tip to avoid it.”
The server sends this prompt sentence to the generative AI model and receives a simplified explanation with explicit steps, typical mistakes, and avoidance tips. The server wraps this result into a markup structure with labels such as “Step 1,” “Common mistake,” and “Tip,” and prepares it for display at the terminal.

### Technical Effect of Emotion-Aware Prompt Construction

By including the emotion indices in the prompt sentence, the server achieves a technical effect of altering the generative AI model's behavior in a way that directly influences subsequent computational processes and physical controls. Because the generative AI model receives constraints encoded as text derived from measured emotion indices, it tends to output plans that reduce user movement, simplify procedures, and spread heavy-load operations over time. When the server converts these plans into control information, the server sends different travel routes and scheduling commands to mobile apparatuses than would be used without emotion information. As a result, the overall system reduces the frequency of error-prone user interactions and reduces the need for repeated or corrective operations, which in turn reduces server processing load and network traffic. In contrast to a manual rephrasing of text instructions, the server's architecture integrates emotion estimation and generative AI-based planning into a coordinated control loop, thereby improving the efficiency and robustness of the computer system itself.
Server configuration for control information generation and mobile apparatus control
The server uses the control component to convert the structured plan data into control information for mobile apparatuses and storage apparatus operations. The server receives a device plan that specifies, for each mobile apparatus, a sequence of locations and associated timing constraints. The server maps each location to a node or segment in a digital map used by the mobile apparatus controllers. The server computes detailed parameters, such as velocities, acceleration limits, and waiting times, by applying optimization functions that consider both the generative plan and local constraints such as battery levels and predicted congestion.
The server then packages these parameters into messages formatted according to the protocol used by the mobile apparatus control subsystem. For example, the server may embed route node lists, speed settings, and stop conditions in a structured message and transmit it through a network interface to a control gateway. The gateway distributes commands to individual mobile apparatuses, which then execute the commands using their onboard controllers. Thus, the server's processing of generative AI output directly results in specific, machine-executable control commands that cause physical movement of the mobile apparatuses in the real world.
The server also generates support information for users. The server selects or adapts the instruction text based on the current emotion indices. If the stress index is high, the server shortens the text using a summarization function, converts paragraphs into bullet lists, and emphasizes key terms through markup. If the confusion index is high, the server ensures that the instruction is split into clear steps and that each step is accompanied by a typical mistake and a tip. The server then sends a user instruction payload to the terminal.

### Terminal Configuration for Display Adaptation and Logging

The terminal receives user instruction payloads from the server via the communication module. The terminal parses the payload and updates the user interface. When the server indicates a simplified display mode, the terminal hides advanced options and shows only essential elements such as storage apparatus location, arrival time, and simple action buttons. When the server indicates emphasis on help, the terminal highlights the help button or tab using graphical effects and preloads the detailed explanation text. The terminal's UI library renders the instructions as text and icons on the display, and the user can follow the guidance step by step.
The terminal continues to log interaction events, such as touches and help invocations, with timestamps and screen identifiers. The terminal periodically aggregates these logs and sends them to the server. The server uses them both for real-time emotion estimation and for offline learning.

### Learning Data Generation and Technical Improvement

The server uses the learning data generation component to construct training datasets. The server associates emotion indices with operation histories and control information. For each session or task, the server forms records that contain features representing pre-task emotion indices, control decisions (for example, route selection, scheduling choices, and instruction format), post-task emotion indices, task durations, error counts, and help usage. The server stores these records in a training dataset. In a training phase, the server uses these records to refine the emotion estimation models and the rules for constructing prompt sentences and translating generative outputs into control information.
For example, the server may train a secondary model that predicts which prompt constructions produce lower error rates and shorter completion times for users with specific emotion profiles. The server may adjust threshold values or constraint phrases based on this model. Because this refinement process is applied to computational parameters and mappings within the server's architecture, the system gradually improves computational efficiency and prediction accuracy, beyond mere automation of a human planner's decisions.
Reasons for Technical Effect and Compliance with Eligibility Guidance
The described configuration produces several technical effects. Emotion indices, computed by concrete neural network and gradient boosting models, are used as formal inputs to subsequent control and prompt generation algorithms, rather than as informal human observations. This allows the server to make routing and scheduling decisions that minimize error-prone operations and redundant user interactions, thereby reducing repeated data transmissions and re-computation on the server. Because the generative AI model receives structured constraints derived from emotion indices, it can produce plans that inherently account for human limitations, and the server can avoid frequent plan revisions.
Furthermore, the integration of multimodal emotion estimation with generative AI prompt sentence generation and device-level control yields a feedback loop that is not present in conventional systems. The server's data flow—from sensor and log features, through trained models, to parameterized control commands-demonstrates that the invention is directed to specific improvements in computer technology, including improved resource allocation on servers, reduced network bandwidth usage, and increased robustness against user input errors. The server implements specific data structures, algorithms, and models, and uses them in a non-conventional and non-generic way to control physical devices and customize human-computer interfaces.

### ALTERNATIVE EMBODIMENTS

In another embodiment, the server may employ different model architectures. For example, the server may use a transformer-based model for emotion estimation from text data representing user chat messages, or may replace the recurrent network for audio with a temporal convolutional network. The gradient boosting model may be replaced with a random forest or a logistic regression model, depending on computational constraints. In some embodiments, the server does not use an external generative AI service, but instead hosts a generative AI model locally. The server loads the model weights into memory and performs inference directly. Even in this case, the server still constructs prompt sentences based on environment information, demand information, and emotion indices, and processes the generated text into control information and support information.
In still other embodiments, the server may apply rule-based post-processing to generative AI outputs. For example, the server may enforce hard constraints by checking the generated routes for conflict with safety zones or capacity limits, and adjusting them using a pathfinding algorithm. The emotion indices can influence not only the prompt sentences but also the post-processing rules, such as stricter limits on user walking distance when fatigue is high. The terminal may be implemented as a stationary kiosk at a storage apparatus location instead of a portable device. In such a variant, the server still sends emotion-aware instructions and rest proposals, and the kiosk still logs operation histories for learning purposes. In all these embodiments, the server, the terminal, and the mobile apparatuses implement specific computational and control functions tied to physical devices and concrete data structures. The inventive concepts therefore extend beyond mere abstract data manipulation and provide a practical application that improves the operation of computer systems and logistics devices.

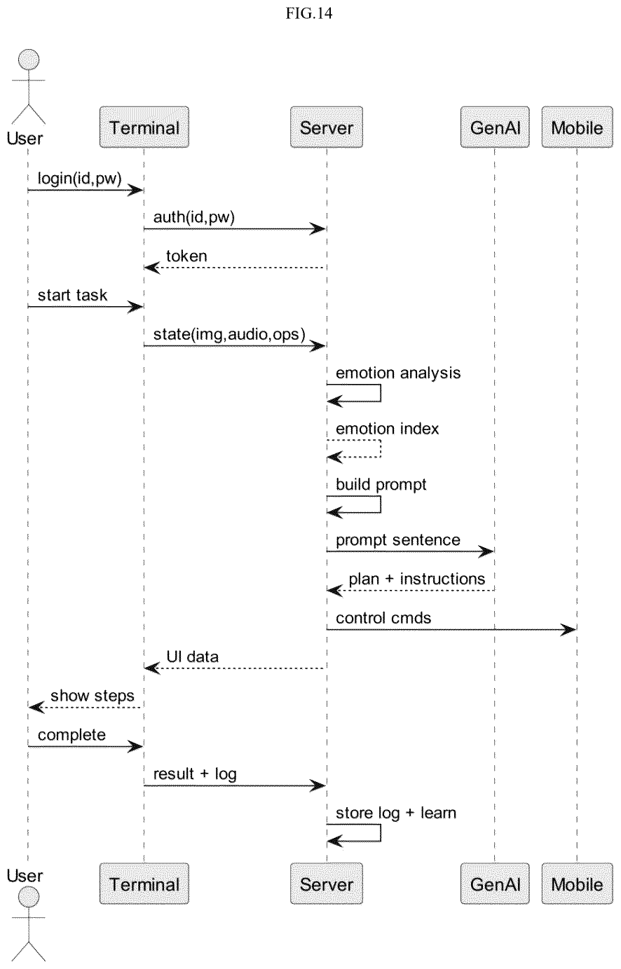

The following describes the processing flow using FIG. 14.

### Step 1:

Server initializes the processing environment.
Server uses a configuration file as input and loads program modules, model files, and database connection settings into memory. Server starts an operating system, a web server, an application server, and a database management system, and allocates CPU, memory, and optional GPU resources. Server reads paths to trained models for facial expression recognition, speech emotion recognition, operation-log analysis, and multimodal fusion from the configuration file, and loads these models through a machine learning framework into internal model instances. As a result of this data loading and parsing operation, server outputs usable model instances and an active database connection pool that will be used in subsequent data processing steps.

### Step 2:

Terminal authenticates the user and acquires initial session data.
Terminal accepts user ID and password as input from the user via a login screen. Terminal converts these inputs into an HTTPS request and transmits the request to the server's authentication endpoint. Server receives the credentials, hashes the password, and performs a comparison against stored authentication records in the database. Based on this comparison, server outputs either an authentication token and initial user-related data (such as profile information and default storage apparatus preferences) or an error response. Terminal receives the authentication token and stores it securely, thereby producing a valid session context as output for later communication.

### Step 3:

Server collects logistics and environment information.
Server uses internal schedulers or triggers as input to periodically query environment tables and demand tables in the database. Server retrieves environment information such as candidate storage apparatus locations, travel times, and congestion indicators, and retrieves item-handling demand information such as requested pickup times, item counts per area, and historical usage frequencies. Server aggregates per-location records into summary structures by computing totals, averages, and time-slot distributions. This aggregation operation transforms raw database rows into a summarized environment-demand dataset, which server outputs for use in planning and prompt sentence generation.

### Step 4:

Terminal acquires user state information and operation information.
Terminal uses the current UI context and user interaction events as input to decide when to capture state data. When the user begins operations related to item receipt or dispatch, terminal activates the camera and microphone to capture a face image and short audio segments, and registers listeners for touch events and button presses. Terminal records each interaction, including timestamps and screen identifiers, into a local operation log. Terminal then packages the face image, the audio data, and a segment of the operation log into a structured message and sends this message to the server. The output of this step is a multipart or structured request containing user state information and operation information for emotion estimation.

### Step 5:

Server preprocesses multimodal user data.
Server receives face image data, audio data, and operation-log data from the terminal as input. Server applies an image processing library to detect and crop a face region from the image, resizes the cropped region to a fixed resolution, and normalizes pixel values. Server transforms the normalized image into a tensor suitable for input to a convolutional neural network. For the audio data, server resamples the waveform, splits it into frames, and computes mel-frequency cepstral coefficients and prosodic features, producing a time-series feature matrix. For the operation-log data, server computes statistics such as touch frequency, error count, and help-button usage per time window. Through these data transformations, server outputs three structured feature sets: an image tensor, an audio feature matrix, and a numeric feature vector for behavior.

### Step 6:

Server estimates emotion indices from the preprocessed data.
Server uses the image tensor, audio feature matrix, behavior feature vector, and optional self-report values as input to a set of models. Server inputs the image tensor into a facial expression recognition network, which outputs probabilities over emotion classes; server converts these probabilities into an image-based negative emotion score. Server inputs the audio feature matrix into a recurrent or temporal model, which outputs a vocal stress score. Server inputs the behavior feature vector into a gradient boosting model, which outputs a confusion score. Server combines these scores with any self-reported fatigue values into a multimodal feature vector and feeds this vector into a fusion network. The fusion network applies weighted sums and non-linear transformations to output numerical emotion indices such as stress index, fatigue index, and confusion index. Server stores these indices in the database and outputs them as emotion index records for subsequent planning and prompt construction.

### Step 7:

Server prepares logistics context for planning.
Server uses current environment-demand summaries and mobile apparatus status information as input. Server queries the database or a control system interface to obtain the current number of unprocessed items, distribution of requested pickup and delivery times, and operational states of mobile apparatuses. Server processes these data by computing totals, sorting by deadlines, and grouping items by storage apparatus location. Server formats the results into structured text fragments, such as “The number of unprocessed parcels is 3000, and 10 mobile units are active.” The output of this step is a set of textual context segments describing the current logistics situation.

### Step 8:

Server generates an emotion-aware prompt sentence for the generative AI model.
Server uses the logistics context segments and the emotion indices as input. Server checks whether the stress index, fatigue index, or confusion index associated with a region or user group exceeds predefined thresholds. If thresholds are exceeded, server generates constraint phrases such as “reduce average walking distance to less than 80% of the current value” or “split procedures into no more than three steps.” Server concatenates the logistics context and these constraints into a coherent natural-language prompt sentence. As a result of this string construction and rule-based insertion, server outputs a prompt sentence that reflects both logistics conditions and user emotion states, for example:
“Current warehouse status is as follows. The number of unprocessed parcels is 3000, and 10 automated transport devices are active. Shipping deadlines and shelf locations for each parcel are listed below. Based on these conditions, please propose (1) an optimal sorting pattern for the parcels, and (2) an approximate movement plan for the automated transport devices. In addition, workers in a specific area show high stress and fatigue indices and operation errors are increasing. Please ensure that their average walking distance is reduced to less than 80% of the current value, that no worker handles more than three items heavier than 20 kg consecutively, and that each work procedure is split into no more than three concise steps.”

### Step 9:

Server calls the generative AI model using the prompt sentence.
Server uses the prompt sentence and generation parameters as input to an HTTP client component. Server constructs a request body that includes the model identifier, the prompt sentence, and parameter values such as maximum output length and randomness settings. Server sends this request to a generative AI model endpoint and waits for a response. The generative AI model returns generated text that includes a description of sorting strategies, mobile apparatus movement plans, and user instructions. Server receives this text and outputs it in raw form and optionally logs the prompt-output pair for audit and learning.

### Step 10:

Server parses the generative AI output into structured control and instruction data. Server uses the generated text as input and scans it for predefined section headers or patterns indicating different content types. Server splits the text into at least a sorting section, a device plan section, and a user instruction section. Server converts statements describing item group assignments into routing tables by mapping item identifiers or groups to storage apparatus locations. Server converts the device plan section into sequences of waypoints, travel times, and conditions for the mobile apparatuses. Server extracts the user instruction section as one or more instruction texts associated with specific tasks or procedures. Through these parsing and mapping operations, server outputs structured control information for mobile apparatuses and formatted support information for users.

### Step 11:

Server converts structured device plans into low-level control information.
Server uses the structured device plans as input to a control translation module. Server maps abstract waypoints to concrete coordinates or zone identifiers used by the mobile apparatus control system. Server computes motion parameters such as optimal speeds, acceleration limits, and waiting times by applying local optimization rules and safety constraints. Server encodes these parameters into control messages following a protocol understood by the mobile apparatus controllers. The output of this step is a set of machine-readable control messages that, when transmitted, cause mobile apparatuses to move along planned routes under the specified constraints.

### Step 12:

Server adapts user instructions to the user's emotion indices.
Server uses the instruction texts from the generative AI output and the user-specific emotion indices as input. If the stress index for a particular user or group is high, server applies summarization or filtering algorithms to remove non-essential details and reorganizes the remaining text into bullet lists. If the confusion index is high, server ensures that the instruction text is split into labeled steps and may request additional simplification from the generative AI model by sending a secondary prompt sentence specifying conditions such as “no technical jargon” and “no more than three steps.” Server then wraps the adapted text into a response structure containing task identifiers, procedure steps, and optional rest proposal messages. The result of this processing is a set of personalized, emotion-aware instruction payloads ready for delivery to terminals.

### Step 13:

Terminal renders emotion-aware instructions and interacts with the user.
Terminal uses the instruction payloads from the server as input. Terminal parses the payloads, updates the user interface to display storage apparatus locations, mobile apparatus arrival times, and stepwise item transfer procedures, and applies display modes indicated by the server (for example, simplified view when stress is high). Terminal highlights help options when confusion is high and preloads detailed explanations for quick access. User views these instructions, follows the indicated steps to perform item receipt or dispatch, and interacts with the terminal by tapping buttons such as “Help” or “Complete.” As output, terminal produces new interaction events and updated display states, which are logged and later sent back to the server.

### Step 14:

Server records operation history, feedback, and corresponding emotion indices.
Server uses uploaded operation logs, user feedback responses, and current emotion indices as input. Server aligns these data by session or task identifier and time, creating combined records that link interaction patterns and explicit feedback with the emotion indices present before and after specific operations. Server also records which control information and instruction formats were used for each case. This data alignment and storage result in structured learning data entries that capture the relationships among user behavior, emotional state, and system decisions.

### Step 15:

Server updates models and prompt sentence rules based on learning data.
Server uses the accumulated learning data as input for offline or periodic retraining procedures. Server feeds pairs of multimodal features and target emotion indices into training routines to refine emotion estimation models, adjusting weights via gradient-based optimization to reduce prediction error. Server may also analyze which prompt sentence variants and constraint phrases produced lower error rates and shorter completion times, and update rule tables or thresholds used in prompt construction. The output of this training and analysis is updated model parameters and revised prompt-generation rules, which the server loads into memory for future operational cycles, thereby improving accuracy, processing efficiency, and robustness of the overall system.
The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

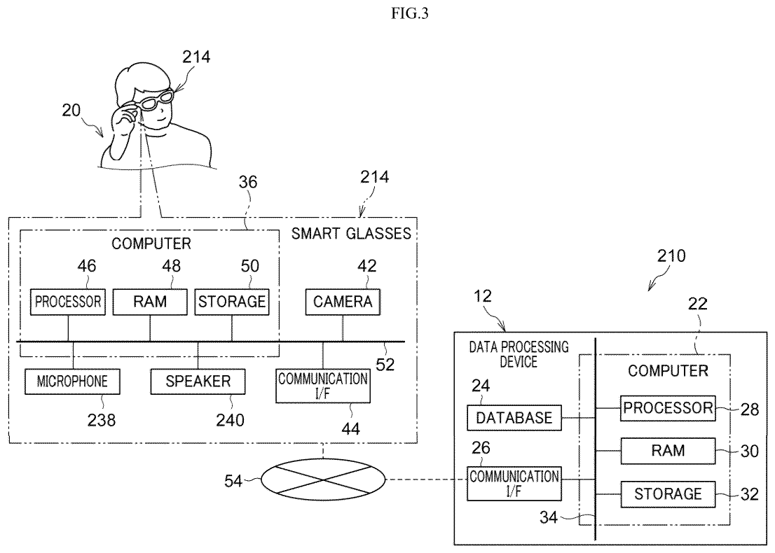

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

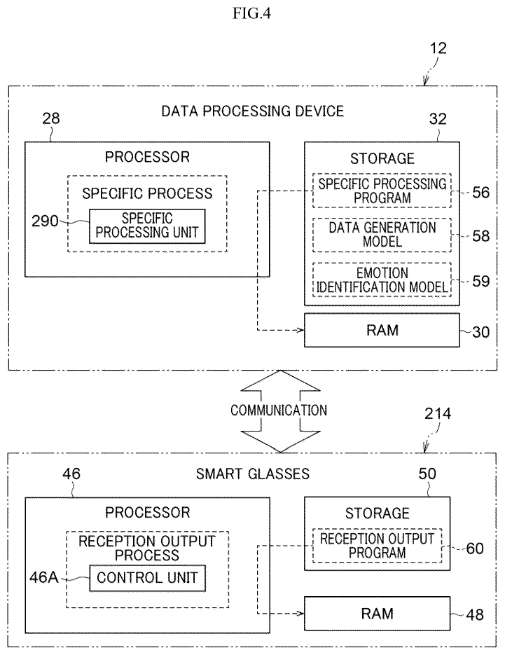

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

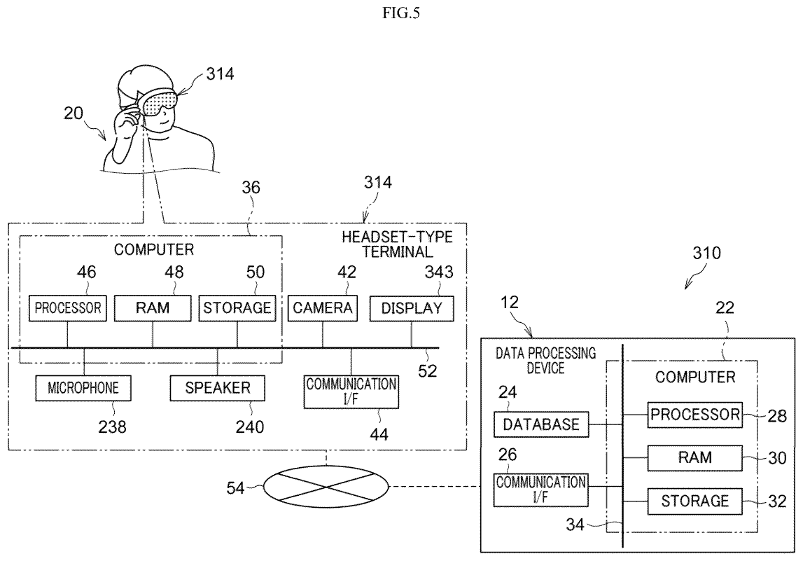

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

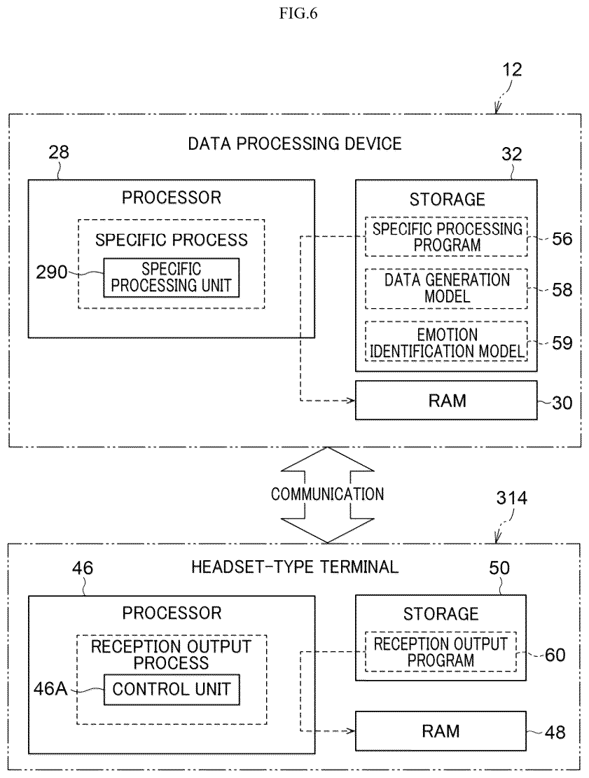

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

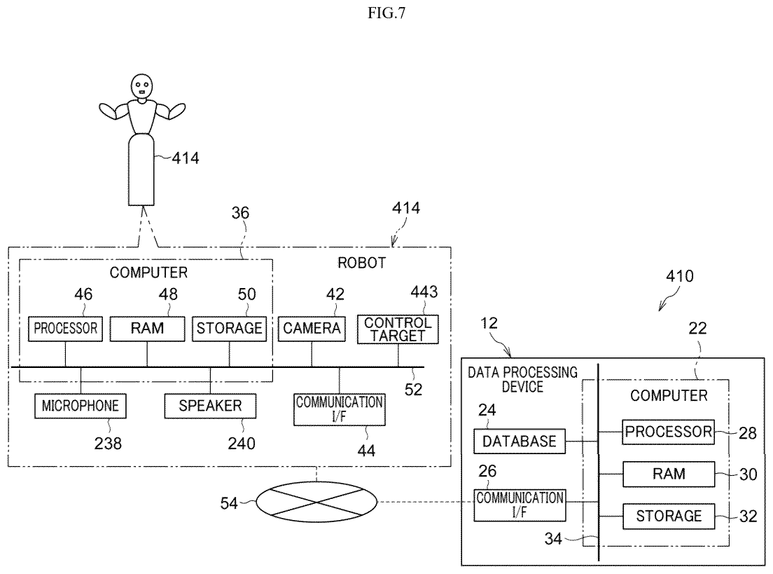

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

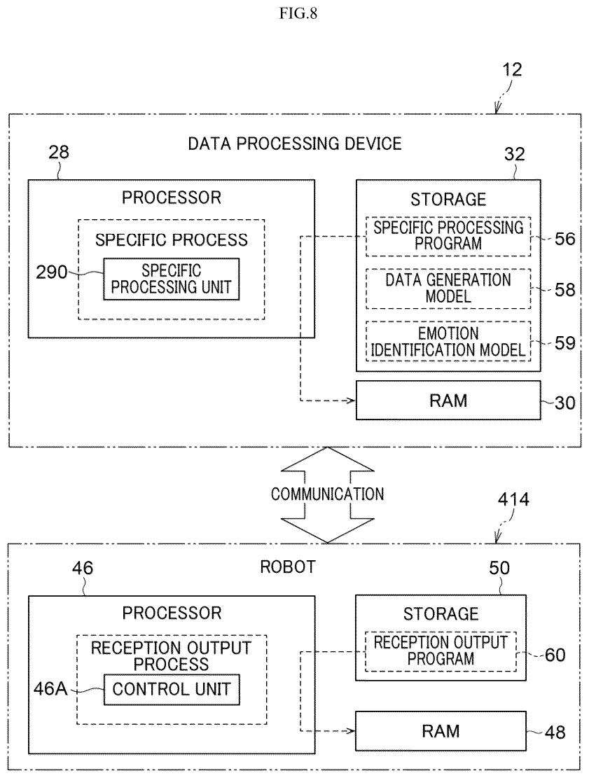

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

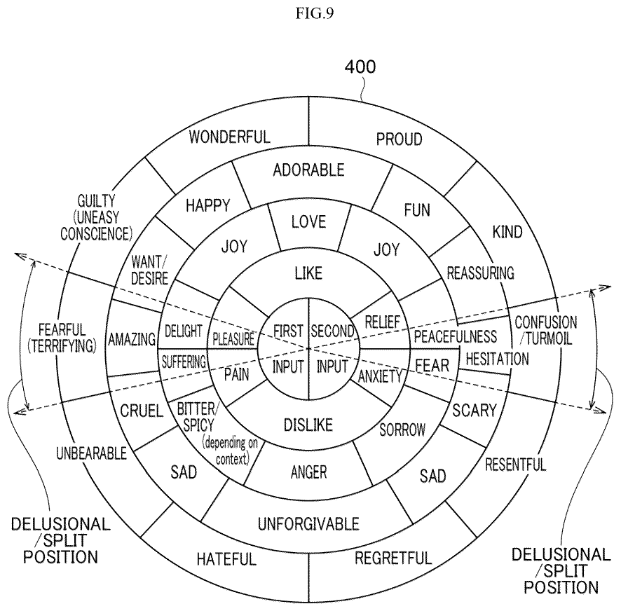

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

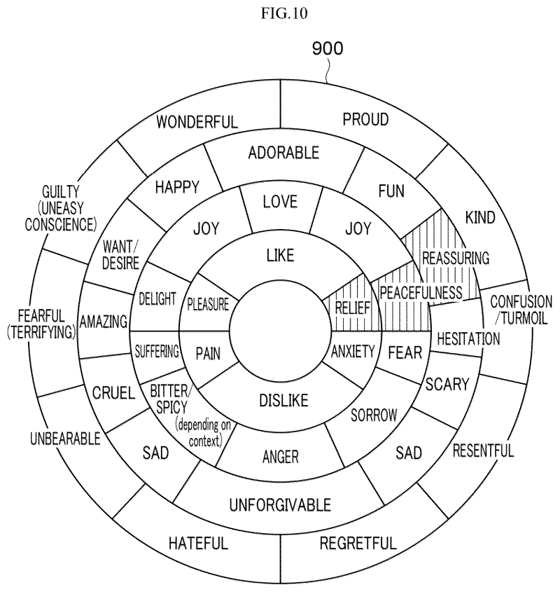

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
control a movable body having an autonomous traveling function so as to operate a storage facility for transfer of an article, the storage facility including a storage unit that performs at least one of receipt and dispatch of the article,
communicate with a user information processing apparatus so as to transmit and receive at least one of position information, reservation information, and feedback information, collect a plurality of types of data including at least user position information acquired from the user information processing apparatus, transportation usage information, delivery history information, and user feedback information,
execute a data processing operation including at least a preprocessing operation, a feature generation operation, and a demand prediction operation on the collected data, and calculate a demand amount for the article for each time period and for each region,
generate an operation plan including at least a placement position and a staying time of the storage unit of the storage facility, based on the calculated demand amount and real-time traffic information,
update processing content of at least the demand prediction operation and the operation plan generation based on the operation plan, the user feedback information, and operation result information of the movable body,
transmit a prompt sentence to a generative AI model and acquire, from the generative AI model, at least one of an analysis policy and an improvement proposal relating to the demand prediction operation, a placement planning operation of the storage unit, or an update operation of the operation plan,
control an update content of the updating of the processing content based on the analysis policy or the improvement proposal acquired from the generative AI model,
manage a reservation by allocating, based on a reservation request received from the user information processing apparatus, a reservation slot corresponding to at least one of a staying time of the storage unit and a storage capacity included in the operation plan,
generate authentication information by encoding authentication data corresponding to the allocated reservation slot into at least one of an authentication code and a proximity wireless signal for use as authentication data for opening and closing control of at least a part of the storage unit,
and verify authentication data transmitted from the storage facility, and, when the authentication data is determined to correspond to a managed reservation slot, output unlocking control information for unlocking at least a portion of the storage unit.

### (Supplementary 2)

The system according to supplementary 1,
wherein the processor is configured to
execute a mathematical optimization process that simultaneously optimizes, based on the demand amount for each time period and for each region, priority information calculated from the user feedback information, and constraint conditions relating to at least one of travel distance, travel time, and storage capacity, at least a position selection and a route selection for a plurality of movable bodies and a plurality of candidate staying locations of the storage facility,
and output, based on a result of the mathematical optimization process, an operation schedule including at least route information and staying time information for the movable body controlled by the processor.

### (Supplementary 3)

The system according to supplementary 1,
wherein the processor is configured to
generate the prompt sentence to the generative AI model so as to include at least one of statistical information of the collected data, prediction error information of the demand prediction operation, and summarized information of the user feedback information,
acquire, as a response to the prompt sentence from the generative AI model, at least one of a demand prediction method, a feature design policy, an operation plan update policy, and a placement priority setting policy corresponding to user attributes,
and automatically adjust at least one of a parameter and an evaluation index used in at least one of the demand prediction operation and the operation plan generation operation based on the acquired method or policy.

### Application Example 1

### (Supplementary 1)

A system comprising a processor, wherein the processor is configured to
read identification information assigned to a plurality of articles, by use of an information reading unit,
acquire position information of the articles and work environment information, by use of an environment information acquisition unit,
store the acquired information in time series form and predict an inflow amount of the articles and a work load, by use of a prediction unit,
determine, on the basis of a prediction result by the prediction unit and attribute information of the articles, a sorting destination and a sorting order of the articles, by use of a sorting plan generation unit,
dynamically optimize, on the basis of a congestion degree and safety calculated from the work environment information, a travel route of a movable body having an autonomous driving function that transports the articles to movement destinations determined by the sorting plan generation unit, by use of a route optimization unit,
control, by use of a movable body control unit, an operation of the movable body and a transport process of the articles in accordance with the travel route and a work instruction determined by the route optimization unit,
provide, by use of a communication unit, state information of the articles, work instruction information, and abnormality notification information to an information processing terminal operated by a user, and receive input information from the information processing terminal, collect evaluation information and operation history information from the user, analyze the collected information in association with work efficiency indices, and update operation conditions of the route optimization unit and the sorting plan generation unit, by use of a feedback analysis unit, and
generate a prompt sentence including an explanation based on an operation history of the system, the prediction result, the congestion degree information, and the evaluation information from the user, input the prompt sentence to a generative information processing model, and automatically or semi-automatically adjust an algorithm or a parameter of the prediction unit, the sorting plan generation unit, and the route optimization unit on the basis of a response obtained from the generative information processing model, by use of a generative information processing cooperation unit.

### (Supplementary 2)

The system according to supplementary 1, wherein the processor is configured to
cause the route optimization unit to update, in accordance with region-specific congestion degree indices calculated from image information and detection information acquired by the environment information acquisition unit, cost values of routes in a route network representing a storage area or a transport area as a function of time, and to repeatedly recalculate the travel route of the movable body having the autonomous driving function on the basis of the updated cost values, and
cause the generative information processing cooperation unit to generate a prompt sentence including the congestion degree indices and delay history of the movable body, input the prompt sentence to the generative information processing model, and change weighting rules for the cost values and congestion determination thresholds on the basis of the response obtained from the generative information processing model.

### (Supplementary 3)

The system according to supplementary 1, wherein the processor is configured to
cause the generative information processing cooperation unit to generate a prompt sentence including a sorting error occurrence situation of the articles, a delay occurrence situation of the articles, comment information from the user, and the work efficiency indices, input the prompt sentence to the generative information processing model, extract from the response obtained from the generative information processing model improvement proposals relating to a priority determination rule of the articles, contents of instructions to an operator, and a presentation format of a user interface, and update, on the basis of the extracted improvement proposals, at least one of a priority assignment process by the sorting plan generation unit and an information presentation process by the communication unit.

### Example 2

### (Supplementary 1)

A system comprising a processor, wherein the processor is configured to
acquire location information of a user and historical information related to parcel delivery demand, and generate candidate placement locations and travel routes for a mobile body equipped with an autonomous travel function and a parcel storage mechanism, and analyze the acquired location information and the historical information related to parcel delivery demand to calculate an evaluation value for optimizing the placement locations and the travel routes of the mobile body, and determine stop positions, stop durations, and travel paths of the mobile body, and
acquire operation information from a portable terminal device and detection information from one or more sensors provided in the portable terminal device, and estimate an emotional state representing a psychological state of the user based on the operation information and the detection information, and
change at least one of demand prediction conditions used in the analysis, the travel route of the mobile body, the stop duration of the mobile body, and guidance conditions for the user, in accordance with the estimated emotional state, and
generate a prompt sentence comprising at least one of an instruction sentence, a condition description, and a situation description, based on at least the emotional state of the user, the location information of the user, reservation information related to use of the parcel storage mechanism, and operation information of the mobile body, the prompt sentence being input to a generative AI model that probabilistically generates text data, and
input the generated prompt sentence to the generative AI model, obtain a natural language text output from the generative AI model, and generate, based on the natural language text output, guidance information or response information to be presented to the user, and
transmit and receive, to and from the portable terminal device, at least the guidance information or the response information, location information of the mobile body, a predicted arrival time of the mobile body, and information on available service options, and accept, from the user via the portable terminal device, at least one of a service use reservation, a redelivery request, and a support request, and
recalculate, in response to a received redelivery request, the travel route of the mobile body and output updated route information to the mobile body, or output, in response to a received support request, support instruction information including at least the emotional state of the user and a usage situation of the user to a support-side terminal, and
store evaluation information and free-description information acquired from the user in association with at least the emotional state and the guidance information or the response information presented to the user, and generate learning data based on accumulated information so as to update at least classification processing for the emotional state and template selection conditions for generating the prompt sentence.

### (Supplementary 2)

The system according to supplementary 1, wherein the processor is configured to
cause the mobile body with the autonomous travel function to move in accordance with the stop positions and the travel paths determined based on at least one of the emotional state of the user and the parcel delivery demand, and to remain at a corresponding stop position during a time period set based on the emotional state of the user, the parcel delivery demand, or both.

### (Supplementary 3)

The system according to supplementary 1, wherein the processor is configured to
control an application operating on the portable terminal device so that the user is enabled, while viewing the guidance information or the response information, to confirm a location of the parcel storage mechanism, to perform at least one of booking pickup or shipment of a parcel, selecting redelivery, and contacting support personnel, and to use operation information and detection information acquired by the application as input to the estimation of the emotional state and to the generation of the prompt sentence.

### Application Example 2

### (Supplementary 1)

A system comprising a processor, wherein the processor is configured to
collect environment information and item-handling demand information related to candidate installation locations for a storage apparatus that performs transfer of items, and user state information and operation information related to a user who utilizes the storage apparatus, analyze the environment information and the item-handling demand information to determine an installation location of the storage apparatus and to generate an optimization policy for a travel route of a mobile apparatus having an autonomous travel function, estimate an emotional state of the user by calculating at least one emotion index on the basis of the user state information and the operation information,
generate a prompt sentence for input to a generative AI model on the basis of the item-handling demand information and the emotion index, transmit the prompt sentence to the generative AI model, and acquire, from the generative AI model, control information related to the travel route or operation of the storage apparatus and support information to be presented to the user,
determine the travel route and operation parameters of the mobile apparatus on the basis of the control information acquired from the generative AI model, and cause a user terminal to output the support information to the user,
record a correspondence among an operation history and feedback information acquired from the user terminal, the emotion index, and the control information, and generate learning data to improve generation of the prompt sentence or determination of the control information, and cause a communication interface to allow the user, via an information processing terminal having at least one of a portable terminal and a display apparatus, to view at least one of a location of the storage apparatus, scheduled arrival information of the mobile apparatus, item transfer procedures, and rest proposal messages, and to reserve receipt and dispatch of an item by operating the information processing terminal.

### (Supplementary 2)

The system according to supplementary 1, wherein the processor is configured to
control the mobile apparatus having the autonomous travel function so that the mobile apparatus moves in accordance with the installation location of the storage apparatus and the travel route determined by the analysis of the environment information and the item-handling demand information and by cooperation with the generative AI model, and so that the mobile apparatus stays at the installation location during a designated time period.

### (Supplementary 3)

The system according to supplementary 1, wherein the processor is configured to
control a user interface executed on the information processing terminal configured as a portable information terminal such that, when the emotion index satisfies a predetermined condition, a display format is dynamically switched to perform at least one of reducing an amount of display information, displaying stepwise procedure explanations, emphasizing help information, and presenting a rest proposal message.

What is claimed is:

1. A system comprising:
circuitry configured to:
receive, via a communication interface coupled to a packet-switched network, geolocation data streams from a plurality of terminal devices and time-series demand data from at least one data source coupled to the packet-switched network;
input the geolocation data streams and the time-series demand data to a recurrent neural network to compute predicted demand values for each of a plurality of spatial regions over a prediction horizon;
generate, based on the predicted demand values and real-time traffic data received via the communication interface, a sequence of waypoint coordinates and dwell-time parameters for an autonomous mobile unit comprising a LiDAR sensor array, an image sensor, and a satellite positioning receiver;
transmit the sequence of waypoint coordinates and the dwell-time parameters to the autonomous mobile unit via the communication interface;
construct a prompt data structure encoding statistical features of the geolocation data streams and prediction error metrics, transmit the prompt data structure to a generative neural network model, and receive from the generative neural network model parameter adjustment data for updating weights of the recurrent neural network; and
allocate time-slot entries in a scheduling data structure stored in a storage device coupled to the packet-switched network, each time-slot entry associating a terminal device identifier with a waypoint coordinate and a time interval, and generate cryptographic authentication tokens for controlling access to a compartment of the autonomous mobile unit.

2. The system according to claim 1, wherein the geolocation data streams include latitude and longitude coordinates with associated timestamps received from positioning sensors of the plurality of terminal devices, and wherein the time-series demand data includes historical transaction volume records and seasonal pattern indicators received from the at least one data source.

3. The system according to claim 2, wherein the circuitry preprocesses the geolocation data streams by aggregating the latitude and longitude coordinates into spatial density maps for each of the plurality of spatial regions at configurable time granularity, and concatenates the spatial density maps with the historical transaction volume records to form structured input tensors for the recurrent neural network.

4. The system according to claim 3, wherein the circuitry further integrates transportation usage data received from public transit data sources via the communication interface into the structured input tensors, the transportation usage data representing passenger volume at transit stations within each spatial region.

5. The system according to claim 1, wherein the recurrent neural network comprises a long short-term memory network or a gated recurrent unit network trained on the geolocation data streams and the time-series demand data, and wherein the circuitry periodically retrains the recurrent neural network using newly accumulated data stored in the storage device.

6. The system according to claim 5, wherein the circuitry generates the sequence of waypoint coordinates by solving a constrained optimization problem that minimizes total travel distance of the autonomous mobile unit subject to constraints including the predicted demand values exceeding a threshold for each waypoint, the dwell-time parameters satisfying minimum service duration requirements, and the real-time traffic data indicating traversability of road segments between consecutive waypoints.

7. The system according to claim 6, wherein the circuitry dynamically recomputes the sequence of waypoint coordinates during an active route execution in response to updated geolocation data streams or updated real-time traffic data, and transmits revised waypoint coordinates to the autonomous mobile unit via the communication interface.

8. The system according to claim 1, wherein the prompt data structure includes a structured text sequence encoding at least the predicted demand values, the prediction error metrics computed as a difference between previously predicted values and actual observed values, and feature importance scores derived from the recurrent neural network.

9. The system according to claim 8, wherein the generative neural network model comprises a transformer-based architecture with a plurality of self-attention layers, and wherein the parameter adjustment data received from the generative neural network model includes at least one of modified feature weighting coefficients, suggested hyperparameter values for the recurrent neural network, and recommended modifications to the structured input tensors.

10. The system according to claim 9, wherein the circuitry automatically applies the parameter adjustment data by updating the weights of the recurrent neural network using the modified feature weighting coefficients and retraining the recurrent neural network with the suggested hyperparameter values, and stores a record associating the parameter adjustment data with resulting prediction accuracy metrics in the storage device.

11. The system according to claim 1, wherein the autonomous mobile unit processes point cloud data from the LiDAR sensor array and image frame data from the image sensor to detect obstacles and road boundaries, and executes a path-following controller to navigate between consecutive waypoint coordinates while maintaining a safe distance from detected obstacles.

12. The system according to claim 11, wherein the autonomous mobile unit further processes traffic signal state data detected by the image sensor using an object detection neural network, and adjusts velocity and stopping behavior at intersections based on the detected traffic signal state data.

13. The system according to claim 1, wherein allocating the time-slot entries includes receiving reservation request data from a terminal device via the communication interface, verifying availability of the requested time interval and waypoint coordinate against existing entries in the scheduling data structure, and transmitting a confirmation data packet including the allocated time-slot entry and the cryptographic authentication token to the terminal device.

14. The system according to claim 13, wherein the cryptographic authentication token comprises a digitally signed data structure encoding the terminal device identifier, the allocated time-slot entry, and a compartment identifier, and wherein the autonomous mobile unit verifies the cryptographic authentication token by validating the digital signature before unlocking the compartment.

15. The system according to claim 1, wherein the circuitry is further configured to:
receive, via the communication interface, feedback data and interaction log data from the plurality of terminal devices; and
update at least one of the predicted demand values and the sequence of waypoint coordinates based on the feedback data.

16. The system according to claim 15, wherein the circuitry estimates a user satisfaction state based on at least one of the interaction log data, text sentiment extracted from the feedback data using a natural language processing model, and response time patterns in the interaction log data.

17. The system according to claim 16, wherein the circuitry adjusts the prompt data structure based on the estimated user satisfaction state to include guidance parameters causing the generative neural network model to prioritize parameter adjustments that improve service quality metrics associated with spatial regions having low satisfaction scores.

18. A system comprising:
a communication interface including a network interface controller coupled to a packet-switched network and configured to transmit and receive data packets;
a memory storing instructions, a recurrent neural network model, a generative neural network model comprising a transformer architecture with a plurality of self-attention layers, and a scheduling data structure; and
circuitry comprising one or more processors coupled to the memory and configured to execute the instructions to:
receive, via the communication interface, geolocation data streams from a plurality of terminal devices and time-series demand data from at least one data source;
preprocess the geolocation data streams into spatial density maps and input the spatial density maps together with the time-series demand data to the recurrent neural network model to compute predicted demand values for a plurality of spatial regions;
generate a sequence of waypoint coordinates and dwell-time parameters for an autonomous mobile unit based on the predicted demand values and real-time traffic data, and transmit the sequence to the autonomous mobile unit via the communication interface;
construct a prompt data structure encoding statistical features and prediction error metrics, transmit the prompt data structure to the generative neural network model, and receive parameter adjustment data for updating the recurrent neural network model;
allocate time-slot entries in the scheduling data structure, each associating a terminal device identifier with a waypoint coordinate and a time interval; and
generate cryptographic authentication tokens for controlling access to a compartment of the autonomous mobile unit.

19. The system according to claim 18, wherein the circuitry is further configured to receive feedback data from the plurality of terminal devices via the communication interface, estimate a user satisfaction state based on sentiment analysis of the feedback data using a natural language processing model stored in the memory, and adjust the prompt data structure based on the estimated user satisfaction state to prioritize parameter adjustments for spatial regions with low satisfaction scores.

20. A method performed by circuitry of a server coupled to a packet-switched network via a communication interface, the method comprising:
receiving, via the communication interface, geolocation data streams from a plurality of terminal devices and time-series demand data from at least one data source coupled to the packet-switched network;
inputting the geolocation data streams and the time-series demand data to a recurrent neural network to compute predicted demand values for each of a plurality of spatial regions over a prediction horizon;
generating, based on the predicted demand values and real-time traffic data received via the communication interface, a sequence of waypoint coordinates and dwell-time parameters for an autonomous mobile unit comprising a LiDAR sensor array, an image sensor, and a satellite positioning receiver;
transmitting the sequence of waypoint coordinates and the dwell-time parameters to the autonomous mobile unit via the communication interface;
constructing a prompt data structure encoding statistical features of the geolocation data streams and prediction error metrics, transmitting the prompt data structure to a generative neural network model, and receiving from the generative neural network model parameter adjustment data for updating weights of the recurrent neural network; and
allocating time-slot entries in a scheduling data structure stored in a storage device coupled to the packet-switched network, each time-slot entry associating a terminal device identifier with a waypoint coordinate and a time interval, and generating cryptographic authentication tokens for controlling access to a compartment of the autonomous mobile unit.
